(19) United States
(12) Patent Application Publication
(10) Pub. No.: US 2026/0116497 A1
(43) Pub. Date: Apr. 30, 2026

(54) DERAILLEUR HANGER ASSEMBLY AND DERAILLEUR HANGER

(71) Applicant: Shimano Inc., Osaka (JP)

(72) Inventors: Tadahisa SHIMOMURA, Osaka (JP); Hiroshi FUJITA, Osaka (JP); Shouta SUYAMA, Osaka (JP); Shunsuke YAMAMOTO, Osaka (JP)

(21) Appl. No.: 19/244,394

(22) Filed: Jun. 20, 2025

Related U.S. Application Data
(63) Continuation-in-part of application No. 18/930,445, filed on Oct. 29, 2024.

(51) Int. Cl. B62M 9/125

(52) U.S. Cl. CPC B62M 9/125

(57) ABSTRACT

A derailleur hanger assembly includes a derailleur hanger, a hanger washer and a hanger bolt. The derailleur hanger includes an axle receiving bore having an internal thread and a frame attachment surface that contacts a bicycle frame in a mounted state. The hanger washer has a bolt receiving opening extending between a frame contact surface and a bolt contact surface. The hanger bolt includes a shaft portion and a head portion. The head portion has an axial contact surface facing in an axial direction of the shaft portion. The shaft portion includes an externally threaded portion that is threadedly coupled to the internal thread of the derailleur hanger. A distance between the axial contact surface and the frame attachment surface is larger than a thickness of the bicycle frame in a state where the hanger bolt is tightened to the derailleur hanger without the hanger washer.

### BACKGROUND

### CROSS-REFERENCE TO RELATED APPLICATIONS

This application is a continuation-in-part application of U.S. Application No. 18/930,445, filed on October 29, 2024. The entire disclosures of U.S. Application No. 18/930,445 is hereby incorporated herein by reference.

### TECHNICAL FIELD

This disclosure generally relates to a derailleur hanger assembly and a derailleur hanger. More specifically, the present disclosure relates to a derailleur hanger assembly for mounting a derailleur to a frame of a bicycle via a derailleur hanger.

### Background Information

Some bicycles have a multi-gear transmission in which a gear ratio of the transmission can be changed to enable a rider to go faster or climb hills more easily. For example, some bicycles have a derailleur that is configured to shift a chain from one sprocket to an adjacent sprocket. In some bicycles, the frame of the bicycle is provided with a derailleur hanger for attaching the derailleur to the frame of the bicycle. The derailleur hanger is separate from the frame of the bicycle. The derailleur hanger generally has one end fixed to the frame of the bicycle and the other end connected to the derailleur. One example of a derailleur hanger is disclosed in U.S. Patent No. 9,227,465 B2 (assigned to Shimano Inc.).

### SUMMARY

Generally, the present disclosure is directed to various features of a derailleur hanger assembly and a derailleur hanger for a bicycle.

In view of the state of the known technology and in accordance with a first aspect of the present disclosure, a derailleur hanger assembly is provided that basically comprises a derailleur hanger, a hanger washer and a hanger bolt. The derailleur hanger includes an axle receiving bore having an internal thread and a frame attachment surface configured to contact with a bicycle frame in a mounted state where the derailleur hanger assembly is mounted to the bicycle frame. The hanger washer has a frame contact surface, a bolt contact surface and a bolt receiving opening extending between the frame contact surface and the bolt contact surface. The hanger bolt includes a shaft portion and a head portion coupled to the shaft portion. The head portion has an axial contact surface facing in an axial direction of the shaft portion. The shaft portion includes an externally threaded portion configured to be threadedly coupled to the internal thread of the derailleur hanger. A distance between the axial contact surface and the frame attachment surface is larger than a thickness of the bicycle frame in a state where the hanger bolt is tightened to the derailleur hanger without the hanger washer.

With the derailleur hanger assembly according to the first aspect, a gap is formed between the bicycle frame and the hanger bolt so that a person can easily notice the absence of the hanger washer where the derailleur hanger is attached to the bicycle frame without the hanger washer.

In accordance with a second aspect of the present disclosure, the derailleur hanger assembly according to the first aspect is configured so that the derailleur hanger includes a first abutment. The hanger bolt includes a second abutment. The first abutment is in contact with the second abutment in a state where the hanger bolt is tightened to the derailleur hanger without the hanger washer.

With the derailleur hanger assembly according to the second aspect, the hanger bolt contacts the derailleur hanger so that the gap is reliably formed between the bicycle frame and the hanger bolt in a state where the hanger bolt is tightened to the derailleur hanger without the hanger washer. In this way, the hanger bolt is prevented from being tightened to the derailleur hanger despite the absence of a hanger washer.

In accordance with a third aspect of the present disclosure, the derailleur hanger assembly according to the second aspect is configured so that the first abutment is spaced apart from the second abutment in a state where the hanger bolt is tightened to the derailleur hanger with the hanger washer.

With the derailleur hanger assembly according to the third aspect, the hanger washer is sandwiched between the hanger bolt and the bicycle frame so that the first abutment is spaced apart from the second abutment in a state where the hanger bolt is tightened to the derailleur hanger with the hanger washer. In this way, contact between the first abutment and the second abutment is avoided in a state where the hanger bolt is tightened to the derailleur hanger with the hanger washer, and thus, the hanger bolt is tightened to the derailleur hanger without being obstructed by contact between the first and second abutment.

In accordance with a fourth aspect of the present disclosure, the derailleur hanger assembly according to any one of the first aspect to the third aspect is configured so that the shaft portion includes a non-threaded portion configured to contact an internal surface defining a mounting opening of the bicycle frame in the mounted state. The head portion contacts the bolt contact surface in the mounted state where the hanger bolt is tightened to the derailleur hanger with the hanger washer between the bicycle frame and the head portion.

With the derailleur hanger assembly according to the fourth aspect, the head portion of the hanger bolt can reliably contact the hanger washer to reduce bending stress on the hanger washer and the thickness of the hanger washer can be reduced.

In accordance with a fifth aspect of the present disclosure, the derailleur hanger assembly according to any one of the first aspect to the fourth aspect is configured so that the head portion has an annular axial recess extending in the axial direction between the shaft portion and the axial contact surface.

With the derailleur hanger assembly according to the fifth aspect, stress in the head portion of the hanger bolt from tightening the hanger bolt to the derailleur hanger can be reliably reduced.

In accordance with a sixth aspect of the present disclosure, the derailleur hanger assembly according to any one of the first aspect to the fifth aspect is configured so that the head portion includes a non-circular tool receiving opening.

With the derailleur hanger assembly according to the sixth aspect, the hanger bolt can be easily tightened and loosened as needed.

In accordance with a seventh aspect of the present disclosure, the derailleur hanger assembly according to any one of the first aspect to the sixth aspect is configured so that the shaft portion includes an internal bore having an internally threaded portion configured to be threadedly coupled to an external thread of a hub axle.

With the derailleur hanger assembly according to the seventh aspect, the hanger bolt can be used to secure both the hub axle and the derailleur hanger to the bicycle frame.

In accordance with an eighth aspect of the present disclosure, the derailleur hanger assembly according to the seventh aspect is configured so that the internal bore has an annular radial recess configured to prevent a free end of the hub axle from interfering with the internal bore of the hanger bolt.

With the derailleur hanger assembly according to the eighth aspect, the annular radial recess can reliably avoid the free end of the hub axle from interfering with the hanger bolt.

In accordance with a ninth aspect of the present disclosure, a derailleur hanger is provided that basically comprises a first portion, a second portion and a third portion. The first portion includes an axle receiving bore configured to receive a hub axle. The second portion includes a derailleur support surface configured to support a derailleur. The third portion connects the first portion and the second portion to define a main body. The main body includes a first side facing in a first direction, a second side facing in a second direction, and a peripheral edge disposed between the first side and the second side. The main body includes a guide configured to aid in attaching and detaching a hub with respect to the derailleur hanger by guiding the hub along the first portion and the third portion. The guide includes a hub contact surface extending along the first portion and the third portion, and an inclined surface adjacent to a section of the peripheral edge and the inclined surface is inclined relative to the hub contact surface.

With the derailleur hanger according to the ninth aspect, the hub axle can be easily and reliably guided by the guide of the derailleur hanger to aid in attaching and detaching a hub to the derailleur hanger.

In accordance with a tenth aspect of the present disclosure, the derailleur hanger according to the ninth aspect is configured so that the hub contact surface is perpendicular to an axial direction of the axle receiving bore.

With the derailleur hanger according to the tenth aspect, the hub can reliably contact the derailleur hanger in the installed state.

In accordance with an eleventh aspect of the present disclosure, the derailleur hanger according to the ninth aspect or the tenth aspect is configured so that the guide further includes an edge surface disposed between the inclined surface and the peripheral edge, the edge surface is less inclined relative to the hub contact surface than the inclined surface.

With the derailleur hanger according to the eleventh aspect, the hub axle can contact the edge surface to make it easier to introduce the hub axle to the guide of the derailleur hanger.

In accordance with a twelfth aspect of the present disclosure, the derailleur hanger according to the eleventh aspect is configured so that the edge surface is a flat surface that is parallel to the hub contact surface.

With the derailleur hanger according to the twelfth aspect, the contact of the hub axle with the edge surface for introducing the hub axle to the guide of the derailleur hanger can be improved.

In accordance with a thirteenth aspect of the present disclosure, the derailleur hanger according to any one of the ninth aspect to the twelfth aspect is configured so that the main body further includes a ridge surface, the hub contact surface is recessed relative to the ridge surface with respect to the axial direction to form an abutment surface between the hub contact surface and the ridge surface.

With the derailleur hanger according to the thirteenth aspect, the hub axle can contact the ridge surface to make it easier to introduce the hub axle to the guide of the derailleur hanger.

In accordance with a fourteenth aspect of the present disclosure, the derailleur hanger according to the thirteenth aspect is configured so that the abutment surface has an entrance portion and a guiding portion. The guiding portion extends between the first portion and the entrance portion. The entrance portion is arranged along a ridge line that extends so as to be inclined with respect to the guiding portion as view in the axial direction.

With the derailleur hanger according to the fourteenth aspect, the hub axle can contact the entrance portion and the guiding portion to make it easier to introduce the hub axle to the guide of the derailleur hanger.

In accordance with a fifteenth aspect of the present disclosure, the derailleur hanger according to any one of the ninth aspect to the fourteenth aspect is configured so that the inclined surface includes a front part that is longer in a hub guiding direction than other parts of the inclined surface.

With the derailleur hanger according to the fifteenth aspect, the hub axle can be easily and reliably guided by the inclined surface to aid in attaching the hub axle to the derailleur hanger.

In accordance with a sixteenth aspect of the present disclosure, a derailleur hanger is provided that basically comprises a first portion, a second portion and a third portion. The first portion includes an axle receiving bore configured to receive a hub axle. The second portion includes a fixing bolt receiving bore configured to receive a fixing bolt to support a derailleur. The third portion connects the first portion and the second portion. The first portion, the second portion and a third portion define a main body having an inner side facing towards a bicycle center plane of a bicycle frame in a mounted state where the derailleur hanger assembly is mounted to the bicycle frame. The inner side includes a chain contact surface located adjacent to a sprocket tooth of an outermost sprocket of the bicycle in the mounted state. The inner side includes an opening definition surface defining an opening of the fixing bolt receiving bore. The chain contact surface is disposed in a plane extending perpendicular to an axial direction of the axle receiving bore. The opening definition surface is disposed in the plane. The chain contact surface is spaced from an inward surface of the sprocket tooth of the outermost sprocket by a first axial distance that is smaller than a width of a chain.

With the derailleur hanger according to the sixteenth aspect, the derailleur hanger is configured so that the chain does not stack within the chain contact surface and the outermost sprocket when the chain drops.

In accordance with a seventeenth aspect of the present disclosure, the derailleur hanger according to the sixteenth aspect is configured so that the chain contact surface is spaced from a tooth tip of the sprocket tooth of the outermost sprocket such that the tooth tip aligns with an inner chain plate of the chain as view in parallel to the plane of the chain contact surface where an outer chain plate of the chain contacts the chain contact surface.

With the derailleur hanger according to the seventeenth aspect, it is possible to reliably avoid the chain from stacking within the chain contact surface and the outermost sprocket when the chain drops.

In accordance with an eighteenth aspect of the present disclosure, the derailleur hanger according to the sixteenth aspect or the seventeenth aspect is configured so that the first axial distance is smaller than a second axial distance between the chain contact surface and a farthest link surface of an outer link of the chain defining an inner space of the outer link.

With the derailleur hanger according to the eighteenth aspect, it is possible to reliably avoid the chain from stacking within the chain contact surface and the outermost sprocket when the chain drops.

In accordance with a nineteenth aspect of the present disclosure, the derailleur hanger according to any one of the sixteenth aspect to the eighteenth aspect is configured so that the main body includes an outer side facing in a direction opposite the first side and a peripheral edge disposed between the outer side and the inner side, and the second portion of the main body includes a first chamfer on the inner side adjacent to the peripheral edge for avoiding interference with a derailleur in the mounted state.

With the derailleur hanger according to the nineteenth aspect, the first chamfer aids in avoiding interference between the derailleur hanger and a derailleur in the mounted state.

In accordance with a twentieth aspect of the present disclosure, the derailleur hanger according to any one of the sixteenth aspect to the nineteenth aspect is configured so that the main body includes an outer side facing in a direction opposite the first side and a peripheral edge disposed between the outer side and the inner side, and the second portion of the main body includes a second chamfer on the inner side adjacent to the peripheral edge for avoiding the chain from riding on the derailleur hanger where the chain rotates in a reverse pedaling direction.

With the derailleur hanger according to the twentieth aspect, the second chamfer aids in avoiding the chain from riding on the derailleur hanger where the chain rotates in a reverse pedaling direction.

Also, other objects, features, aspects and advantages of the disclosed derailleur hanger assembly and the disclosed derailleur hanger will become apparent to those skilled in the art from the following detailed description, which, taken in conjunction with the annexed drawings, discloses preferred embodiments of the disclosed derailleur hanger assembly and the derailleur hanger.

### BRIEF DESCRIPTION OF THE DRAWINGS

Referring now to the attached drawings which form a part of this original disclosure, illustrative embodiments are shown.

FIG. 1 is a rear perspective view of a rear portion of a bicycle frame having a rear hub mounted to the bicycle frame, a sprocket assembly mounted to the rear hub, and a rear derailleur mounted to the bicycle frame by a derailleur hanger assembly in accordance with a first embodiment.

FIG. 2 is a right side elevational view of the rear portion of the bicycle frame, the rear hub, the rear derailleur and the derailleur hanger assembly illustrated in FIG. 1.

FIG. 3 is a rear elevational view of the rear portion of the bicycle frame, a rear hub axle of the rear hub and the derailleur hanger illustrated in FIGS. 1 and 2.

FIG. 4 is an inside perspective view of a right rear frame portion, and the derailleur hanger assembly illustrated in FIGS. 1 to 3.

FIG. 5 is an outside perspective view of a right rear frame portion, and the derailleur hanger assembly illustrated in FIGS. 1 to 4.

FIG. 6 is an inside elevational view of the right rear portion of the bicycle frame and the derailleur hanger assembly illustrated in FIGS. 1 to 5.

FIG. 7 is an outside elevational view of the right rear portion of the bicycle frame, and the derailleur hanger assembly illustrated in FIGS. 1 to 6.

FIG. 8 is an inside elevational view of the right rear portion of the bicycle frame and the derailleur hanger illustrated in FIGS. 1 to 7 in which the derailleur hanger has been deflected causing the pin to break and the derailleur hanger to move relative to the bicycle frame.

FIG. 9 is a cross sectional view of the right rear portion of the bicycle frame and the derailleur hanger assembly illustrated in FIGS. 1 to 8 as seen along section line 9 – 9 of FIG. 6.

FIG. 10 is an enlarged cross sectional view of the right rear portion of the bicycle frame and the derailleur hanger assembly illustrated in FIG. 9.

FIG. 11 is an exploded outside perspective view of the right rear frame portion, and the derailleur hanger assembly illustrated in FIGS. 1 to 10.

FIG. 12 is an exploded inside perspective view of the right rear frame portion and the derailleur hanger assembly illustrated in FIGS. 1 to 11.

FIG. 13 is a first perspective view of the derailleur hanger of the derailleur hanger assembly illustrated in FIGS. 1 to 12.

FIG. 14 is a second perspective view of the derailleur hanger illustrated in FIG. 13.

FIG. 15 is a first side elevational view of the derailleur hanger illustrated in FIGS. 13 and 14.

FIG. 16 is a second side elevational view of the derailleur hanger illustrated in FIGS. 13 to 15.

FIG. 17 is a front edge elevational view of the derailleur hanger illustrated in FIGS. 13 to 16.

FIG. 18 is a rear edge elevational view of the derailleur hanger illustrated in FIGS. 13 to 17.

FIG. 19 is a top edge view of the derailleur hanger illustrated in FIGS. 13 to 18.

FIG. 20 is a bottom edge view of the derailleur hanger illustrated in FIGS. 13 to 19.

FIG. 21 is a cross sectional view of a right rear portion of a bicycle frame and a derailleur hanger assembly in accordance with a first modification.

FIG. 22 is a first perspective view of a derailleur hanger assembly in accordance with a second modification.

FIG. 23 is a second perspective view of the derailleur hanger illustrated in FIG. 22.

FIG. 24 is an inside perspective view of a right rear frame portion, and a derailleur hanger assembly mounted to the right rear frame portion in accordance with a third modification.

FIG. 25 is an outside perspective view of the right rear frame portion, and the derailleur hanger assembly illustrated in FIG. 24.

FIG. 26 is an outside elevational view of the right rear portion of the bicycle frame, and the derailleur hanger assembly illustrated in FIGS. 24 and 25.

FIG. 27 is an exploded inside perspective view of the right rear frame portion and the derailleur hanger assembly illustrated in FIGS. 23 to 25.

FIG. 28 is a first cross sectional view of the right rear portion of the bicycle frame and the derailleur hanger assembly illustrated in FIGS. 24 to 27 as seen along section line 28 – 28 of FIG. 26.

FIG. 29 is a second cross sectional view of the right rear portion of the bicycle frame and the derailleur hanger assembly illustrated in FIGS. 23 to 27 as seen along section line 29 – 29 of FIG. 26.

FIG. 30 is an inside perspective view of a right rear frame portion, and a derailleur hanger assembly in accordance with another embodiment.

FIG. 31 is an outside perspective view of the right rear frame portion, and the derailleur hanger assembly illustrated in FIG. 30.

FIG. 32 is an inside elevational view of the right rear portion of the bicycle frame and the derailleur hanger assembly illustrated in FIGS. 30 and 31.

FIG. 33 is an outside elevational view of the right rear portion of the bicycle frame, and the derailleur hanger assembly illustrated in FIGS. 30 to 32.

FIG. 34 is an inside elevational view of the right rear portion of the bicycle frame and the derailleur hanger illustrated in FIGS. 30 to 33 in which the derailleur hanger has been deflected causing the pin to break and the derailleur hanger to move relative to the bicycle frame.

FIG. 35 is a cross sectional view of the right rear portion of the bicycle frame and the derailleur hanger assembly illustrated in FIGS. 30 to 34 as seen along section line 35 – 35 of FIG. 32.

FIG. 36 is an enlarged cross sectional view of a part of the right rear portion of the bicycle frame and the derailleur hanger assembly illustrated in FIG. 35.

FIG. 37 is a cross sectional view of the right rear portion of the bicycle frame and the derailleur hanger assembly illustrated in FIGS. 30 to 36 as seen along section line 37 – 37 of FIG. 32.

FIG. 38 is a cross sectional view, similar to FIG. 37 of the right rear portion of the bicycle frame and the derailleur hanger assembly but in which the hanger washer has been omitted and the hanger bolt tightened

FIG. 39 is an exploded outside perspective view of the right rear frame portion, and the derailleur hanger assembly illustrated in FIGS. 30 to 38.

FIG. 40 is an exploded inside perspective view of the right rear frame portion and the derailleur hanger assembly illustrated in FIGS. 30 to 39.

FIG. 41 is a first perspective view of the derailleur hanger of the derailleur hanger assembly illustrated in FIGS. 30 to 40.

FIG. 42 is a first side elevational view of the derailleur hanger illustrated in FIG. 41.

FIG. 43 is a second perspective view of the derailleur hanger illustrated in FIGS. 41 and 42.

FIG. 44 is a second side elevational view of the derailleur hanger illustrated in FIGS. 41 to 43.

FIG. 45 is a front edge elevational view of the derailleur hanger illustrated in FIGS. 41 to 44.

FIG. 46 is a front edge elevational view of the derailleur hanger illustrated in FIGS. 41 to 45.

FIG. 47 is a bottom perspective elevational view of the derailleur hanger illustrated in FIGS. 41 to 46.

FIG. 48 is a bottom peripheral edge view of the derailleur hanger illustrated in FIGS. 41 to 47.

FIG. 49 is a diagrammatic view illustrating a relationship of an outermost sprocket with respect to the derailleur hanger illustrated in FIGS. 41 to 47.

FIG. 50 is an outside elevational view of the right rear portion of the bicycle frame, and a derailleur hanger assembly having a modified hanger bolt.

FIG. 51 is a cross sectional view of the right rear portion of the bicycle frame and the derailleur hanger assembly illustrated in FIG. 50 as seen along section line 51 – 51 of FIG. 50.

FIG. 52 is an outside elevational view of the right rear portion of the bicycle frame, and a derailleur hanger assembly having a modified hanger bolt.

FIG. 53 is a cross sectional view of the right rear portion of the bicycle frame and the derailleur hanger assembly illustrated in FIG. 50 as seen along section line 53 – 53 of FIG. 52.

FIG. 54 is an outside elevational view of the right rear portion of the bicycle frame, and a derailleur hanger assembly having a modified hanger bolt.

FIG. 55 is a cross sectional view of the right rear portion of the bicycle frame and the derailleur hanger assembly illustrated in FIG. 54 as seen along section line 55 – 55 of FIG. 54.

FIG. 56 is an outside elevational view of the right rear portion of the bicycle frame, and a derailleur hanger assembly having a modified hanger bolt.

FIG. 57 is a cross sectional view of the right rear portion of the bicycle frame and the derailleur hanger assembly illustrated in FIG. 56 as seen along section line 57 – 57 of FIG. 56.

### DETAILED DESCRIPTION

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

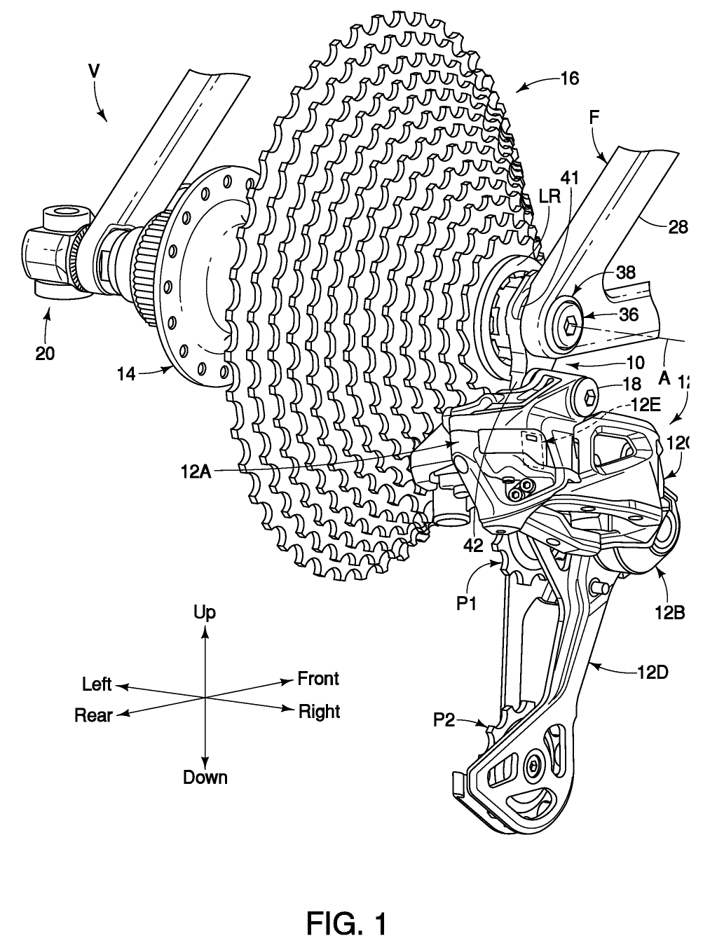

Referring initially to FIGS. 1 to 3, a rear portion of a bicycle V is illustrated that is equipped with a derailleur hanger assembly 10 in accordance with a first embodiment. The bicycle V includes, among other things, a derailleur 12, a rear hub 14 and a rear sprocket assembly 16. In particular, the rear derailleur 12 is mounted to a bicycle frame F of the bicycle V by a derailleur hanger assembly 10 in accordance with a first embodiment. Since bicycles are well known in the bicycle field, the human-powered bicycle V will not be discussed or illustrated in detail herein, except for the portions of the bicycle frame F that relate to the derailleur hanger assembly 10.

As seen in FIG. 1, the bicycle V has a bicycle center plane CP vertically bisecting the bicycle frame F of the bicycle V in a longitudinal direction (a front to rear direction). The bicycle center plane CP passes through a center of the bicycle frame F in a width direction (a left to right direction) of the bicycle frame F. Thus, the bicycle center plane CP separates a left side of the bicycle V from a right side of the bicycle V. The following directional terms “front,” “rear,” “forward,” “rearward,” “left,” “right,” “lateral,” “longitudinal”, “upward,” and “downward,” as well as any other similar directional terms, refer to those directions which are determined on the basis of a rider sitting upright on a seat of the bicycle V while facing a handlebar of the bicycle V.

In the first embodiment, the derailleur 12 is a bicycle rear derailleur that is typically used with a mountain bike. Of course, it will be apparent from this disclosure that the derailleur hanger assembly 10 can be used with other types of derailleurs. Since derailleurs are well known in the bicycle field, the derailleur 12 will not be discussed or illustrated in detail herein, except for as the derailleur 12 relates to the derailleur hanger assembly 10.

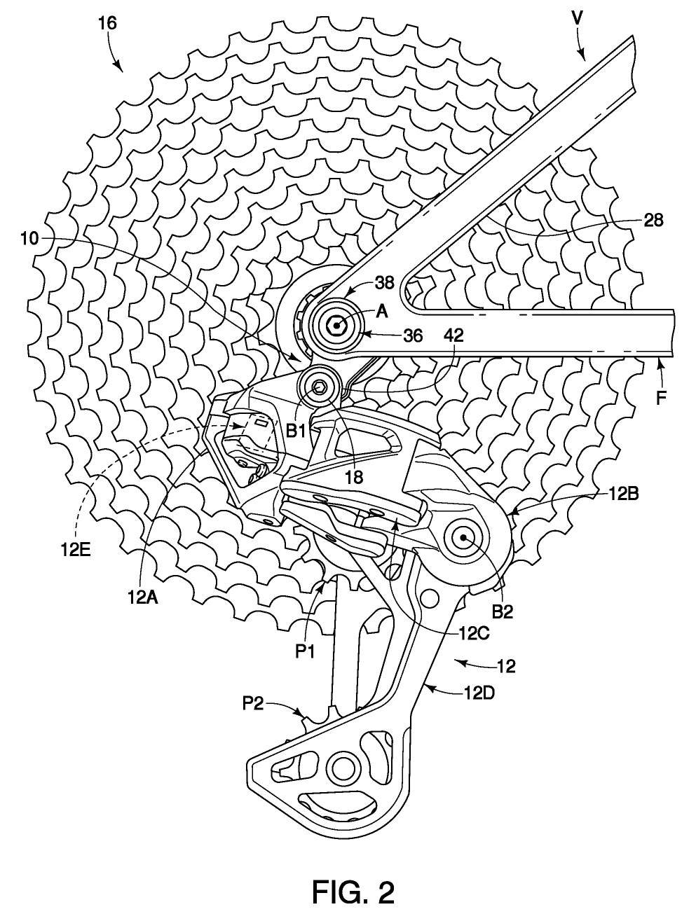

As seen in FIGS. 1 and 2, the derailleur 12 basically comprises a base member 12A, a movable member 12B, a linkage 12C and a chain guide 12D. Here, the derailleur 12 is an electric derailleur having a motor unit 12E. The base member 12A is mounted to the derailleur hanger assembly 10 by a fixing bolt 18. In this way, the base member 12A is configured to be attached to the bicycle frame F of the bicycle V by the derailleur hanger assembly 10. Preferably, the base member 12A is configured to pivot relative to the bicycle frame F about a pivot axis B1, which is defined by the fixing bolt 18. The linkage 12C movably couples the movable member 12B to the base member 12A. The movable member 12B is movably coupled to the base member 12A by the linkage 12C. The chain guide 12D is pivotally coupled to the movable member 12B about a pivot axis B2. Preferably, the chain guide 12D includes at least one pulley. Here, the chain guide 12D includes a first pulley P1 and a second pulley P2. The motor unit 12E is mounted to the base member 12A. The motor unit 12E has a reversible electric motor that is operatively coupled to the linkage 12C for moving the linkage 12C such that the movable member 12B is moved relative to the base member 12A. The electric motor of the motor unit 12E is disposed inside a housing that is mounted to the base member 12A.

Basically, the derailleur 12 is configured to move a chain CN from one sprocket of the rear sprocket assembly 16 to an adjacent sprocket of the rear sprocket assembly 16 in response to either an automatic shift signal from a cycle computer, or a shift signal inputted by a user from an operating device. Here, the derailleur 12 is mounted to the right side of the rear portion of the bicycle frame F by the derailleur hanger assembly 10. The derailleur hanger assembly 10 is configured to support the derailleur 12 to the rear portion of the bicycle frame F such that the derailleur 12 is positioned farther to the right of the bicycle center plane CP as compared to a derailleur mounted to a bicycle frame using a conventional derailleur hanger. Thus, the derailleur hanger assembly 10 is particularly useful for supporting a derailleur when a rear sprocket assembly is provided with a large number of sprockets such as thirteen sprockets in the case of the rear sprocket assembly 16.

As seen in FIG. 3, the rear hub 14 is mounted to the bicycle frame F of the bicycle V by a thru-axle 20. The rear hub 14 includes a hub body 22, a hub axle 24 and a freewheel body 26. The hub axle 24 has a center axis A. The center axis A corresponds a center axis of the thru-axle 20. The center axis A also corresponds to an axis of rotation of the hub body 22 and the freewheel body 26. The hub body 22 and the freewheel body 26 are rotatably mounted on the hub axle 24 by bearings in a conventional manner to rotate about the center axis A. The hub axle 24 is a hollow tube for receiving the thru-axle 20. The thru-axle 20 extends through hub axle 24, and is coupled to a rear portion 28 of the bicycle frame F. In particular, the rear portion 28 of the bicycle frame F has a right mounting opening 30A and a left mounting opening 30B for receiving the thru-axle 20. When the thru-axle 20 is installed to the rear portion 28 of the bicycle frame F, the hub axle 24 and the thru-axle 20 are non-rotatable secured to the rear portion 28 of the bicycle frame F. Thus, the hub axle 24 and the thru-axle 20 can also be jointly referred to as the hub axle of the rear hub 14. The rear portion 28 of the bicycle frame F further includes a pin receiving portion 32 (FIG. 9). Here, the pin receiving portion 32 is a blind bore that is spaced radially from the right mounting opening 30A. Alternatively, the pin receiving portion 32 can be a through bore. The rear portion 28 of the bicycle frame F further includes a restricting member 33. Here, the restricting member 33 is a projection that is spaced radially from the right mounting opening 30A. The functions of the pin receiving portion 32 and the restricting member 33 will be described below.

The rear sprocket assembly 16 is retained on the freewheel body 26 by a locking ring LR. The rear sprocket assembly 16 includes an outermost sprocket 16A. The outermost sprocket 16A is the smallest sprocket of the rear sprocket assembly 16, and the sprocket that is farthest from the bicycle center plane CP. The rear sprocket assembly 16 is non-rotatably mounted to the freewheel body 26 so that the rear sprocket assembly 16 and the freewheel body 26 rotate together. The freewheel body 26 is connected to the hub body 22 via one-way clutch. In this way, a torque is transmitted from the rear sprocket assembly 16 to the hub body 22, in a state where the rear sprocket assembly 16 is rotated by a pedaling action or a drive unit in a forward driving direction. On the other hand, the hub body 22 can rotate in a forward driving direction relative to the freewheel body 26 and the rear sprocket assembly 16 in a state where the rear sprocket assembly 16 is stopped or rotated in a non-driving direction (i.e., opposite the forward driving direction). In the first embodiment, the rear hub 14 is a bicycle rear hub. Rear hubs such as the rear hub 14 are well known in the bicycle field, and thus, the rear hub 14 will not be discussed in further detail herein.

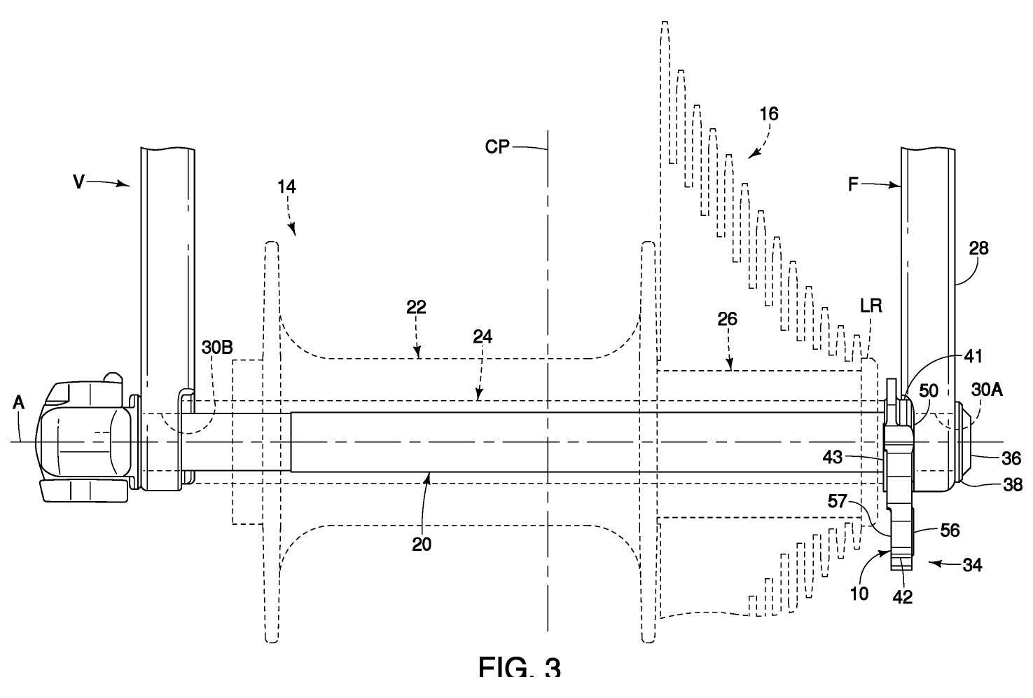

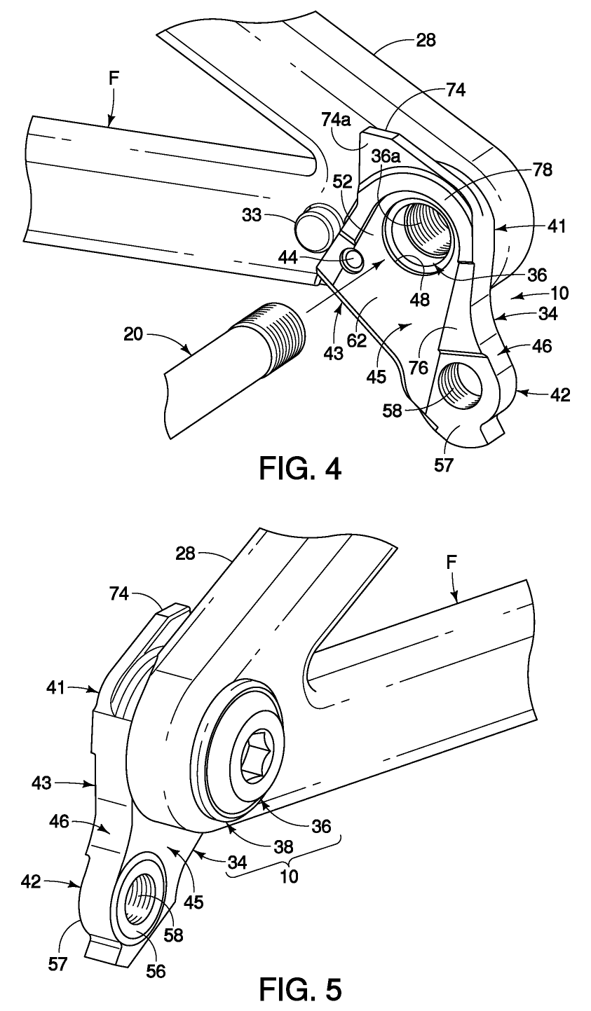

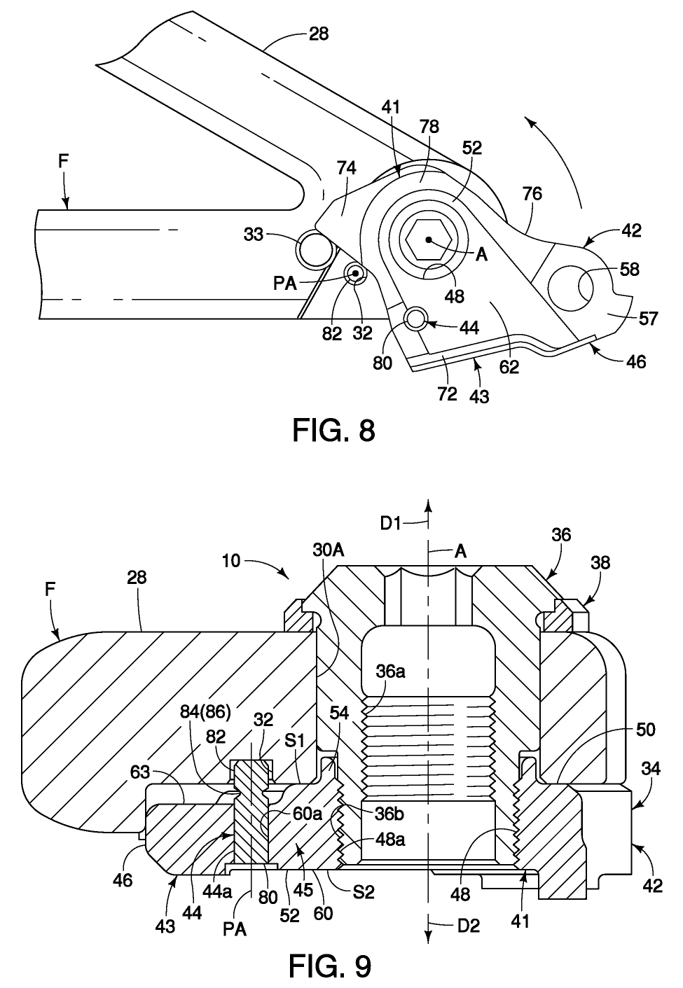

Referring now to FIGS. 4 to 12, the derailleur hanger assembly 10 will now be discussed in more detail. Basically, the derailleur hanger assembly 10 includes a derailleur hanger 34 and a hanger bolt 36. The derailleur hanger 34 is configured to be axially spaced from the locking ring LR with respect to the center axis A. In the words, a gap exists between the locking ring LR and the derailleur hanger 34 so that the locking ring LR does not contact the derailleur hanger 34. Here, the derailleur hanger assembly 10 further includes a hanger washer 38. The hanger washer 38 is preferably made of a metallic material such as stainless steel. The derailleur hanger 34 is a separate part from the rear portion 28 of the bicycle frame F. Specifically, in the first embodiment, the derailleur hanger 34 is fixed to the rear portion 28 of the bicycle frame F by the hanger bolt 36. The derailleur hanger 34 is in an installed state where the derailleur hanger 34 is mounted to the rear portion 28 of the bicycle frame F.

The hanger bolt 36 is preferably made of a metallic material such as aluminum, stainless steel, or the like. The hanger bolt 36 includes an internal thread 36a for threadedly receiving the thru-axle 20 to attach the rear hub 14 to the bicycle frame F in a conventional manner. The internal thread 36a is a preferably a right-hand thread. The hanger bolt 36 further includes an external thread 36b for attaching the derailleur hanger 34 to the rear portion 28 of the bicycle frame F. The external thread 36b is a preferably a left-hand thread. In the installed state of the derailleur hanger 34, a head portion of the hanger bolt 36 contacts and a shaft portion of the hanger bolt 36 is threadedly attached to the derailleur hanger 34. With the derailleur hanger 34 in the installed state, the thru-axle 20 is threadedly attached to the hanger bolt 36 for attaching the rear hub 14 to the bicycle frame F.

As seen in FIGS. 4 and 5, the derailleur hanger 34 comprises a first portion 41, a second portion 42, a third portion 43 and a pin 44. The third portion 43 is coupled to the first portion 41 and the second portion 42. In the first embodiment, the first portion 41, the second portion 42 and the third portion 43 are formed as a one-piece member of a suitable material. The first portion 41, the second portion 42 and the third portion 43 can also be referred to as a main body 45 of the derailleur hanger 34. For example, the first portion 41, the second portion 42 and the third portion 43 is formed of a hard rigid material such as a metal alloy, or a fiber reinforced plastic (e.g., plastic reinforced with carbon fibers or glass fibers). The derailleur hanger 34 further comprises a peripheral edge 46. The peripheral edge 46 forms the periphery of the main body 45.

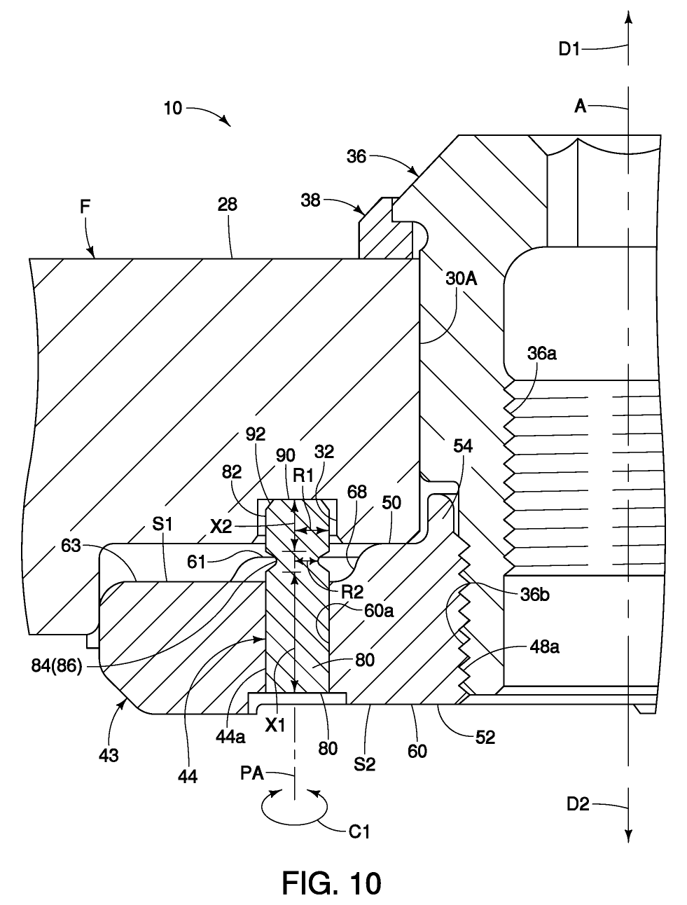

In the first embodiment, as seen in FIGS. 9 and 10, the the pin 44 is a separate member from the main body 45 (e.g., the first portion 41, the second portion 42 and the third portion 43). In particular, the pin 44 is a separate member that is fixed to the third portion 43. The main body 45 has a first side S1 that faces a first direction D1 in the mounted state, and a second side S2 that faces a second direction D2 opposite the first direction D1. Here, the pin 44 protrudes from the first side S1 of the main body 45 in the first direction D1, and is partly received in the pin receiving portion 32 of the bicycle frame F.

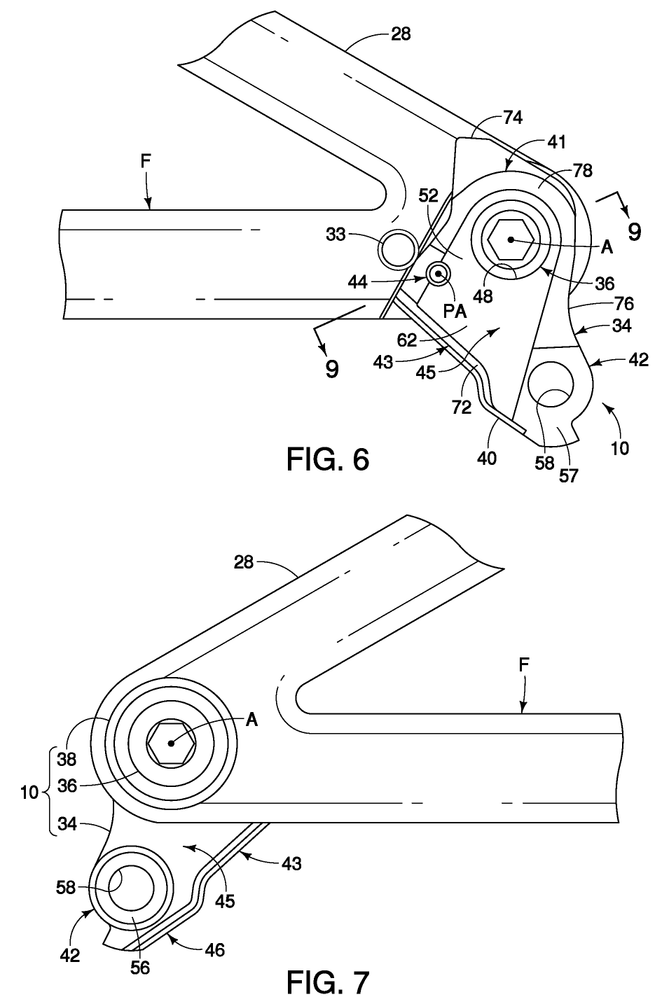

As seen in FIGS. 4 and 6, the pin 44 prevents the derailleur hanger 34 from pivoting relative to the bicycle frame F about the center axis A of the hub axle 24 in the installed state. However, the pin 44 is configured to break upon application of a predetermined force (e.g., a torque about the center axis A) or higher to the pin 44. When the pin 44 has broken due to the application of a predetermined force or higher to the pin 44 in a rearward direction, the derailleur hanger 34 can pivot rearwardly relative to the bicycle frame F until the derailleur hanger 34 contacts the restricting member 33. On the other hand, after the pin 44 breaks, the restricting member 33 contacts the derailleur hanger 34 to prevent forward movement of relative to the bicycle frame F about the center axis A. Moreover, the restricting member 33 is configured to restrict rearward movement of the derailleur hanger 34 about the center axis A of the hub axle 24 after the pin 44 breaks. The restricting member 33 is also configured to contact the derailleur hanger 34 prior to the pin 44 breaking to prevent forward movement of relative to the bicycle frame F. In this way, the pin 44 is protected from breaking upon a force being applied to the derailleur hanger 234 in a forward direction relative to the bicycle frame F. Of course, when the pin 44 is broken, the restricting member 33 limits the range movement of the derailleur hanger 234 about the center axis A of the hub axle 24 within a predetermined range.

Preferably, the material of the pin 44 is different from the material of the main body 45 of the derailleur hanger 34. For example, the main body 45 of the derailleur hanger 34 is made of a first metallic material (e.g., aluminum) and the pin 44 is made of a second metallic material (e.g., stainless steel). Alternatively, the main body 45 and the pin 44 can be made of the same metallic material as needed and/or desired. Alternatively, the main body 45 of the derailleur hanger 34 is made of a metallic material (e.g., aluminum) and the pin 44 is made of a non-metallic material (e.g., plastic). In any case, the pin 44 is configured to break at a target torque as described below.

Referring back to FIG. 3, the first portion 41 is configured to be mounted to the hub axle 24. In the first embodiment, the first portion 41 is mounted to the hub axle 24 via the thru-axle 20. Specifically, as seen in FIGS. 4, 11 and 12, the first portion 41 includes an axle receiving bore 48. The axle receiving bore 48 is configured to receive the hub axle 24. More specifically, the axle receiving bore 48 is configured to threadedly receive the hanger bolt 36, which in turn is configured to threadedly receive the thru-axle 20 for mounting the hub axle 24 to the first portion 41. The axle receiving bore 48 includes an internal thread 48a.

As seen in FIGS. 9 and 10, the first portion 41 is sandwiched between an inner facing surface of the rear portion 28 of the bicycle frame F and an end surface of the hub axle 24 and in the installed state. In other words, in the installed state, the first portion 41 is configured to contact the inner facing surface of the rear portion 28 of the bicycle frame F, and the first portion 41 is configured to contact an end surface of the hub axle 24. In particular, the first portion 41 further includes a frame attachment surface 50. The first portion 41 further includes a hub contact surface 52. The frame attachment surface 50 faces the first direction D1 in the mounted state. The hub contact surface 52 faces the second direction D2 in the mounted state. Thus, the hub contact surface 52 faces in the opposite direction from the frame attachment surface 50 in the mounted state. The frame attachment surface 50 is configured to contact with the bicycle frame F in the mounted state. More specifically, the frame attachment surface 50 contacts the inner facing surface of the rear portion 28 of the bicycle frame F. Thus, the frame attachment surface 50 can also be referred to as a frame contact surface. The frame attachment surface 50 is held in contact with the inner facing surface of the rear portion 28 by the hanger bolt 36, which is attached to the thru-axle 20. The frame attachment surface 50 is disposed in a plane P1 extending perpendicular to an axial direction of the axle receiving bore 48. The hub contact surface 52 is configured to contact the rear hub 14 in the mounted state. More specifically, the hub contact surface 52 is configured to contact the end surface of the hub axle 24 in the mounted state.

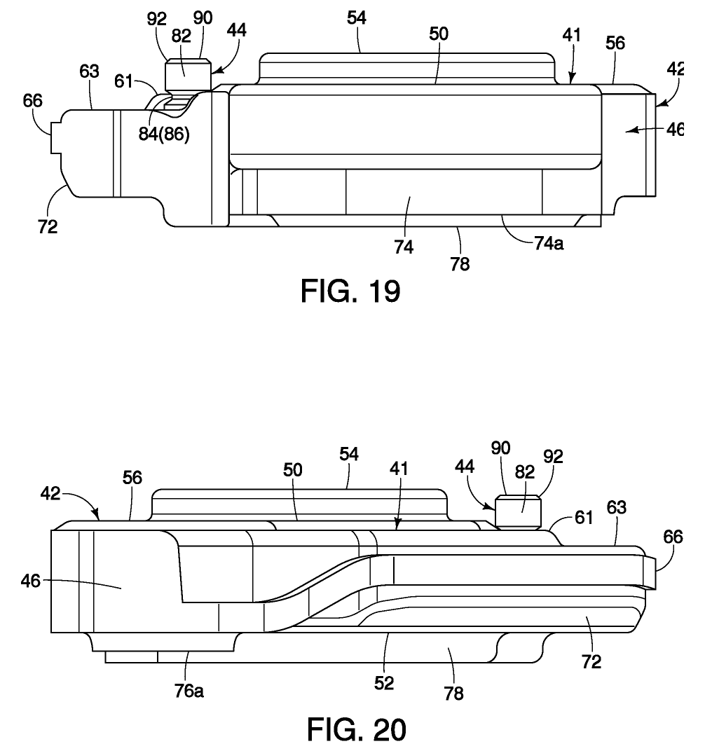

As seen in FIGS. 9, 11, 13 and 17 to 20, the first portion 41 further includes a tubular part 54. The tubular part 54 is positioned in the mounting opening 30A in the mounted state. Here, the tubular part 54 is configured to avoid contact with the bicycle frame F in the mounted state. In other words, a gap exists between the tubular part 54 and the surface that defines the mounting opening 30A as seen in FIG. 9. As a result, the thru-axle 20 is aligned with the bicycle frame F only by the hanger bolt 36. In other words, the derailleur hanger 34 does not contribute the alignment and the positioning of the thru-axle 20 to the bicycle frame F.

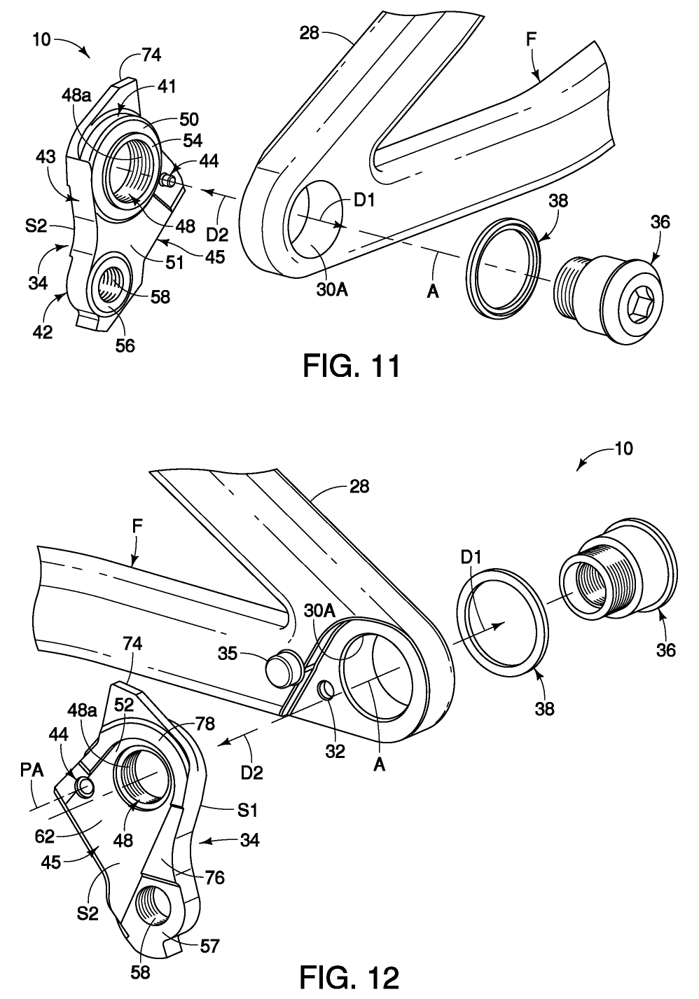

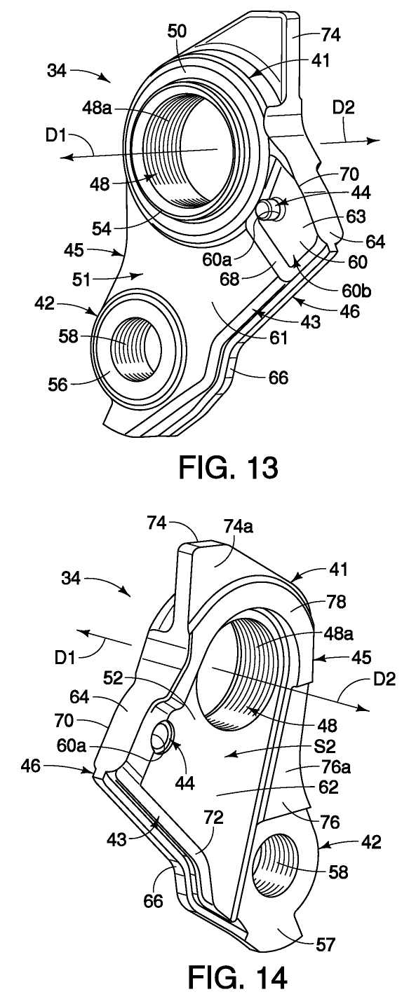

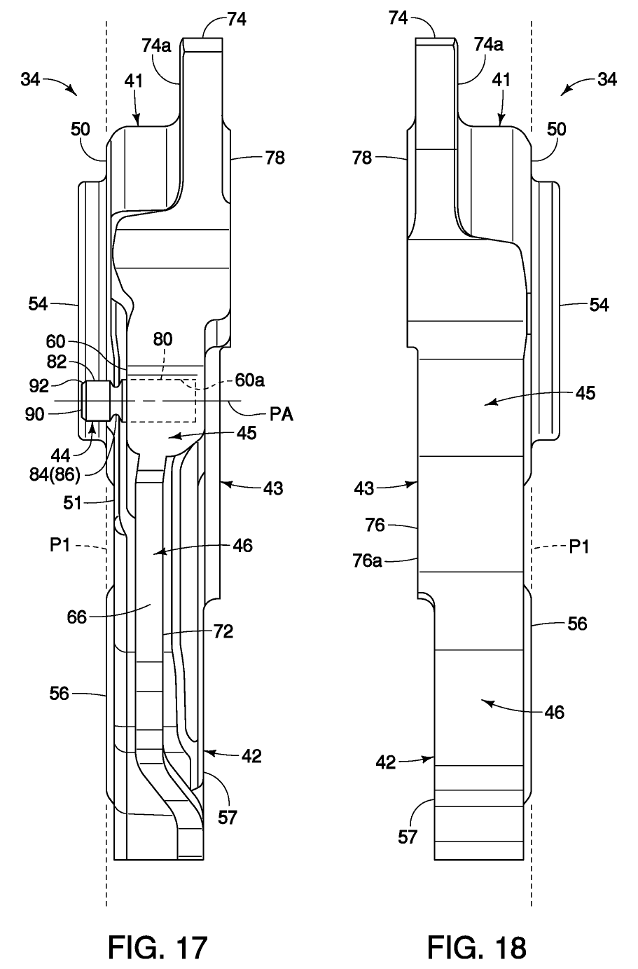

Referring back to FIGS. 1 and 2, the second portion 42 is configured to support the derailleur 12. More specifically, the second portion 42 includes a derailleur support surface 56 configured to support the derailleur 12. In particular, the derailleur 12 contacts the derailleur support surface 56 in the first embodiment. The second portion 42 also includes an additional derailleur support surface 57 that faces in the opposite direction to the derailleur support surface 56. In the case where the derailleur has a mounting portion that sandwiches the second portion 42, the mounting portion of the derailleur can contact both the derailleur support surface 56 and the additional derailleur support surface 57. Also, the second portion 42 includes a fixing bolt receiving bore 58. Here, in the first embodiment, the fixing bolt receiving bore 58 includes an internal thread that threadedly receives the fixing bolt 18 of the derailleur 12. Alternatively, the fixing bolt receiving bore 58 can be unthreaded and the derailleur 12 can be attached to the second portion 42 using a bolt and a nut. As seen in FIGS. 11 and 13, the derailleur support surface 56 faces in the first direction D1 in the mounted state. As seen in FIGS. 17 and 18, the derailleur support surface 56 is disposed in the plane P1.

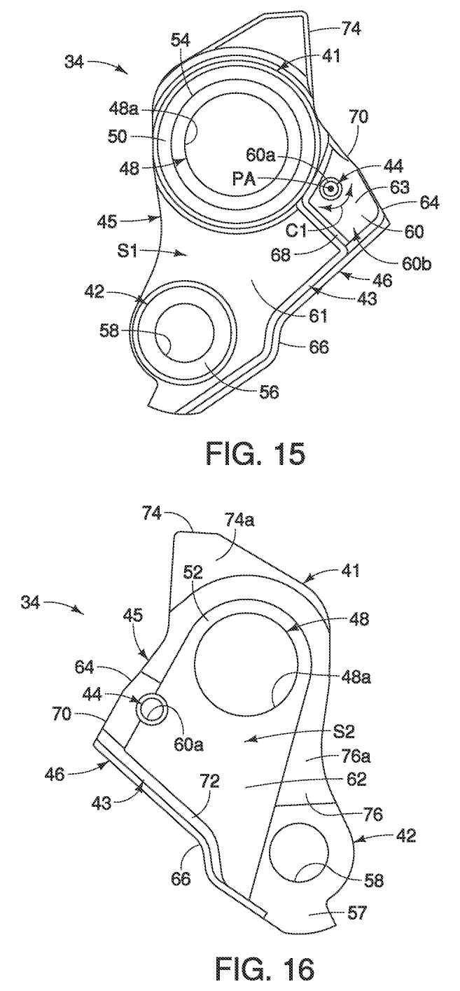

As seen in FIGS. 13 and 15, the derailleur hanger 34 further comprises a pin attachment portion 60. Here, in the first embodiment, the third portion 43 includes the pin attachment portion 60. In particular, the pin attachment portion 60 is provided on the third surface 63. The pin 44 is provided to the pin attachment portion 60. Here, in the first embodiment, the pin attachment portion 60 includes a pin attachment hole 60a. The pin 44 is fixed in the pin attachment hole 60a as described below. Preferably, the third surface 63 surrounds the pin attachment hole 60a. The pin attachment portion 60 has a recess 60b. The third surface 63 is a bottom surface of the recess 60b.

In the first embodiment, as seen in FIGS. 13 to 20, the third portion 43 includes a first surface 61, a second surface 62 and a third surface 63. The first surface 61 faces in the first direction D1. The second surface 62 faces in the second direction D2 opposite the first direction D1. The third surface 63 faces in the first direction D1. The third surface 63 is offset from the first surface 61 in the second direction D2. Also, here, the third surface 63 is offset from the frame attachment surface 50 in the second direction D2. In particular, the third surface 63 is axially offset from the frame attachment surface 50 with respect to the axle receiving bore 48. Moreover, the third surface 63 is offset from the derailleur support surface 56 in the second direction D2. Further, the derailleur support surface 56 and the third surface 63 are non-overlapping as viewed in a direction parallel to an axial direction of the axle receiving bore 48.

Referring to FIGS. 9 and 11, the tubular part 54 protrudes relative to the first surface 61 around the axle receiving bore 48. In this way, the axle receiving bore 48 is disposed in the mounting opening 30A of the bicycle frame F in the mounted state. Here, the frame attachment surface 50 encircles the tubular part 54 so that the frame attachment surface 50 contacts the bicycle frame F.

Referring to FIGS. 13 to 20, the derailleur hanger 34 further comprises a first peripheral edge portion 64. The derailleur hanger 34 further comprises a second peripheral edge portion 66. The first peripheral edge portion 64 and the second peripheral edge portion 66 are individual sections of the peripheral edge 46. The first peripheral edge portion 64 is disposed between the second surface 62 and the third surface 63. The first surface 61 and the third surface 63 are interconnected by a connecting surface 68. The third surface 63 and the first peripheral edge portion 64 define a corner 70 opposite to the second portion 42.

As best seen in FIG. 14, the second peripheral edge portion 66 is disposed between the first surface 61 and the second surface 62. The second peripheral edge portion 66 includes an inclined surface 72. The inclined surface 72 is adjacent to the second surface 62 of the third portion 43. The inclined surface 72 is configured to aid in attaching and detaching a hub with respect to the hanger 34.

Referring now to FIGS. 14 and 16, the derailleur hanger 34 further comprises a first chain restriction portion 74 including a first chain restriction surface 74a. The first chain restriction surface 74a can also be referred to as a chain contact surface. The first chain restriction surface 74a faces in the second direction D2 and is offset from the second surface 62 in the second direction D2. Optionally, the derailleur hanger 34 can include other chain restriction structures for preventing a chain from jamming between the first portion 41 of the derailleur hanger 34 and the smallest or outermost sprocket 16A of the rear sprocket assembly 16. For example, here, the derailleur hanger 34 further comprises a second chain restriction portion 76 including a second chain restriction surface 76a. The second chain restriction surface 76a can also be referred to as a chain contact surface. The second chain restriction surface 76a faces in the second direction D2 and is offset from the second surface 62 in the second direction D2. Here, the second chain restriction surface 76a lies in the same plane as the first chain restriction surface 74a. The first chain restriction portion 74 and the second chain restriction portion 76 cooperate to aid in preventing a chain from jamming between the first portion 41 of the derailleur hanger 34 and the smallest or outermost sprocket 16A of the rear sprocket assembly 16.

As seen in FIGS. 12 and 14, the derailleur hanger 34 further comprises includes a collar 78. The collar 78 protrudes from the hub contact surface 52 in a direction parallel to the center axis A toward the bicycle center plane CP. The collar 78 has a U-shape as viewed in a direction parallel to the center axis A. The collar 78 is dimensioned to partially surround the hub axle 24 in the installed state. The collar 78 aids in preventing a chain from jamming between the first portion 41 of the derailleur hanger 34 and the smallest sprocket of the rear sprocket assembly 16. In other words, the collar 78 constitutes a diverting region on which a chain can slip transversely with respect to a longitudinal direction of the chain.

Referring now to mainly FIGS. 9 and 10, the pin 44 basically includes a first part 80 and a second part 82. In the first embodiment, the first part 80 and the second part 82 are cylindrical. Alternatively, the first part 80 can be stepped so that the first part 80 includes a head or flange portion and a shaft portion. However, preferably, the first part 80 does not include a head or flange portion, because a length of the press-fit can be longer without a head or flange portion. As a result, the pin 44 can be reliably fixed to the derailleur hanger 34.

The first part 80 is coupled to the third portion 43. Specifically, the first part 80 is provided to the pin attachment portion 60. More specifically, the first part 80 of the pin 44 is fixed to the pin attachment hole 60a. Here, for example, the first part 80 of the pin 44 is press-fitted into the pin attachment hole 60a. In the first embodiment, the process of press-fitting the pin 44 into the pin attachment hole 60a is aided by the third surface 63 surrounding the pin attachment hole 60a. In particular, the third surface 63 is provided surround the pin attachment hole 60a so that the jig can reliably support the derailleur hanger 34 during the press-fit process. In this way, the pin 44 can be reliably and firmly fixed to the derailleur hanger 34. Alternatively, the first part 80 of the pin 44 can be retained in the pin attachment hole 60a by bonding. The pin 44 protrudes relative to the first surface 61 and does not protrude from the second surface 62. The second part 82 projects in the first direction D1 from the third surface 63 to be received in the pin receiving portion 32 of the bicycle frame F in a mounted state where the derailleur hanger 34 is mounted to the bicycle frame F. In this way, the pin 44 prevents movement of the derailleur hanger 34 relative to the bicycle frame F about the center axis A.

Here, the pin 44 further includes a frangible part 84. Here, the frangible part 84 includes a groove 86. The frangible part 84 is disposed between the first part 80 and the second part 82. The frangible part 84 is configured to break relative to the first part 80 and the second part 82 upon application of a predetermined force or higher to the pin 44. For example, the predetermined force at which the frangible part 84 breaks can be set to a torque of 1.5 times or more than the friction torque applied by the hanger bolt 36. Preferably, the frangible part 84 is disposed at a position between the first surface 61 and the third surface 63. More preferably, the frangible part 84 is configured to be disposed outside of the pin receiving portion 32 of the bicycle frame F in the mounted state. In the first embodiment, as seen in FIG. 10, the first part 80 and the second part 82 of the pin 44 each has a first radius R1 and the frangible part 84 has a second radius R2. The first radius R1 is larger than the second radius R2. Preferably, as illustrated, the second radius R2 is more than half of the first radius R1.

In the case where the pin 44 breaks along the frangible part 84 from an impact to the derailleur hanger 34, the second part 82 of the pin 44 is broken off and can be received in the space between the third surface 63 and the bicycle frame F during rotation of the derailleur hanger 34 while absorbing the impact. Alternatively, in the case where the pin 44 breaks along the frangible part 84 from an impact to the derailleur hanger 34, the second part 82 of the pin 44 that is broken off can be removed or ejected out of the space the third surface 63 and the bicycle frame F during rotation of the derailleur hanger 34 while absorbing the impact. Therefore, damage occurring to the bicycle frame F from the second part 82 being broken off and being sandwiched between the derailleur hanger 34 and the bicycle frame F can be suppressed.

In the first embodiment, the pin 44 includes a pin axis PA extending in the first direction D1 and a circumferential surface 44a extending in a circumferential direction C1 around the pin axis PA as illustrated in FIG. 10. The groove 86 extends circumferentially on the circumferential surface 44a to define a continuous groove. Here, the groove 86 has a V-shape. Alternatively, the groove 86 can be discontinuous and/or can have another shape.

Basically, the pin 44 includes a first end 88 and a second end 90. The second end 90 is spaced from the first end 88 in the first direction D1. A first distance X1 between the groove 86 and the first end 88 is larger than a second distance X2 between the groove 86 and the second end 90. The second part 82 of the pin 44 has the free end 90. The free end 90 is disposed opposite of the third surface 63 with respect to the first surface 61. Here, the free end 90 of the pin 44 has a chamfer 92.

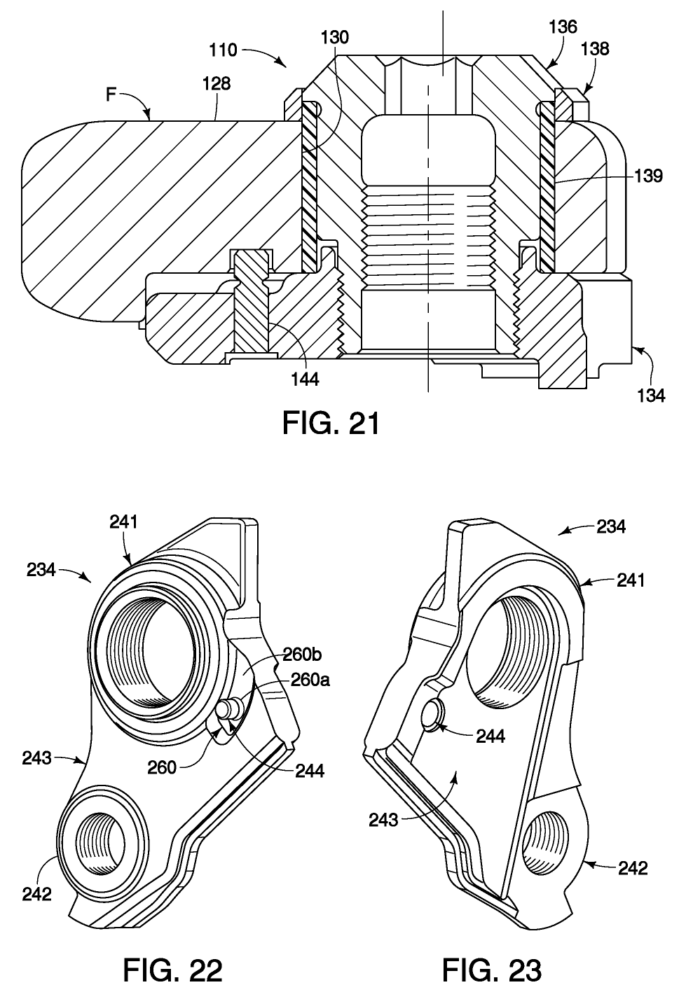

Referring now to FIG. 21, a derailleur hanger assembly 110 is illustrated in accordance with a first modification. Basically, the derailleur hanger assembly 110 comprises a derailleur hanger 134, a hanger bolt 136 and a hanger washer 138. The derailleur hanger 134 is identical to the derailleur hanger 34 of the first embodiment. Thus, the derailleur hanger 134 is provided with a pin 144 to prevent rotation of the derailleur hanger 134 relative to the frame until a predetermined force is applied to the derailleur hanger 134 causing the pin 144 to break. Also, the hanger bolt 136 is identical to the hanger bolt 36 of the first embodiment. In this modification, the frame has a mounting opening 130 that is larger than in diameter than the mounting opening 30A. Here, the derailleur hanger assembly 110 further comprises a sleeve 139 that is positioned in the mounting opening 130 and that receives the hanger bolt 136. The sleeve 139 is preferably made of a plastic material, while the hanger washer 138 is made of a metallic material such as stainless steel. Also, preferably, the sleeve 139 is molded onto the washer 138 so that the washer 138 and the sleeve 139 are integrated together. The sleeve 139 can help with alignment of the hanger bolt 136.to the bicycle frame F.

Referring now to FIGS. 22 and 23, a derailleur hanger 234 is illustrated in accordance with a second modification. Here, the derailleur hanger 234 can be used with either the derailleur hanger assembly 10 or the derailleur hanger assembly 110. Similar to the first embodiment, the derailleur hanger 234 comprises a first portion 241, a second portion 242, a third portion 243 and a pin 244. The derailleur hanger 234 is identical to the derailleur hanger 34 of the first embodiment, except that the third portion 243 has been modified. Specifically, the third portion 243 includes a pin attachment portion 260 having a pin attachment hole 260a and a recess 260b where the recess 260b is arc shaped.

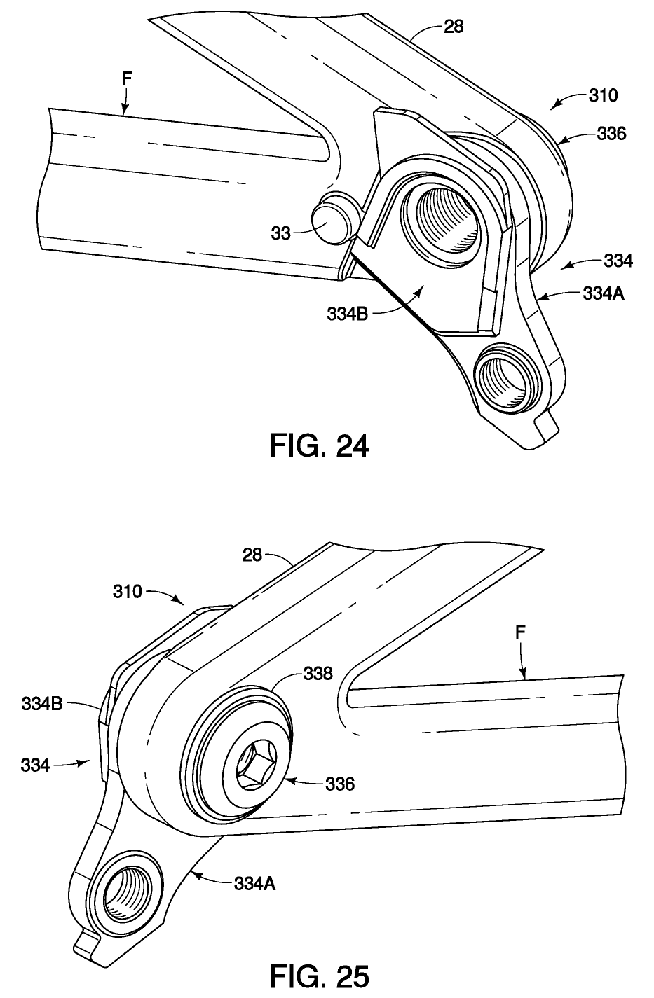

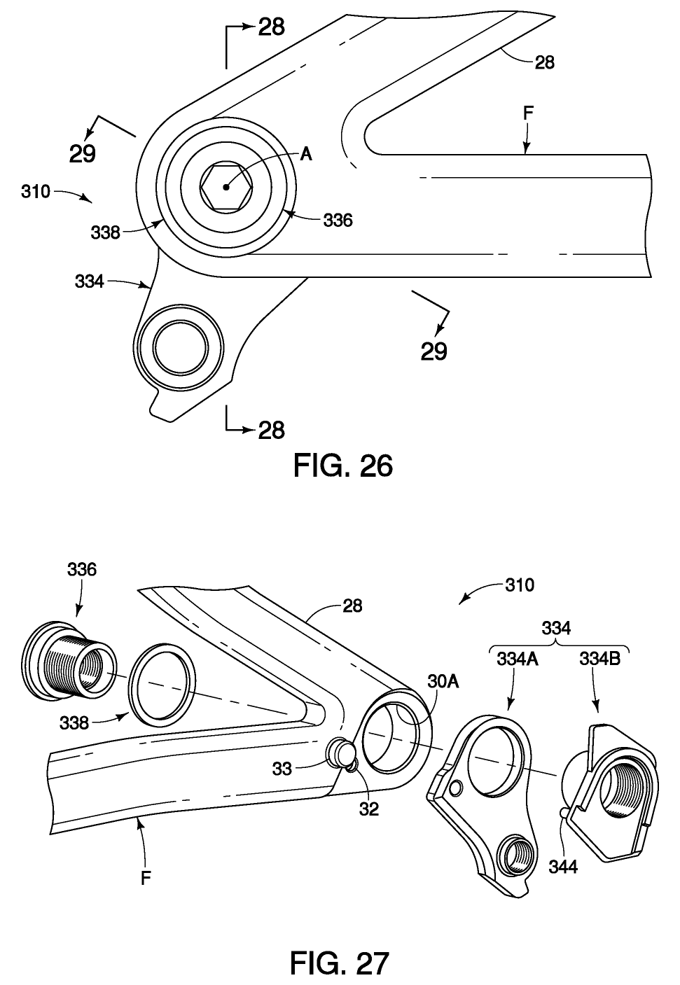

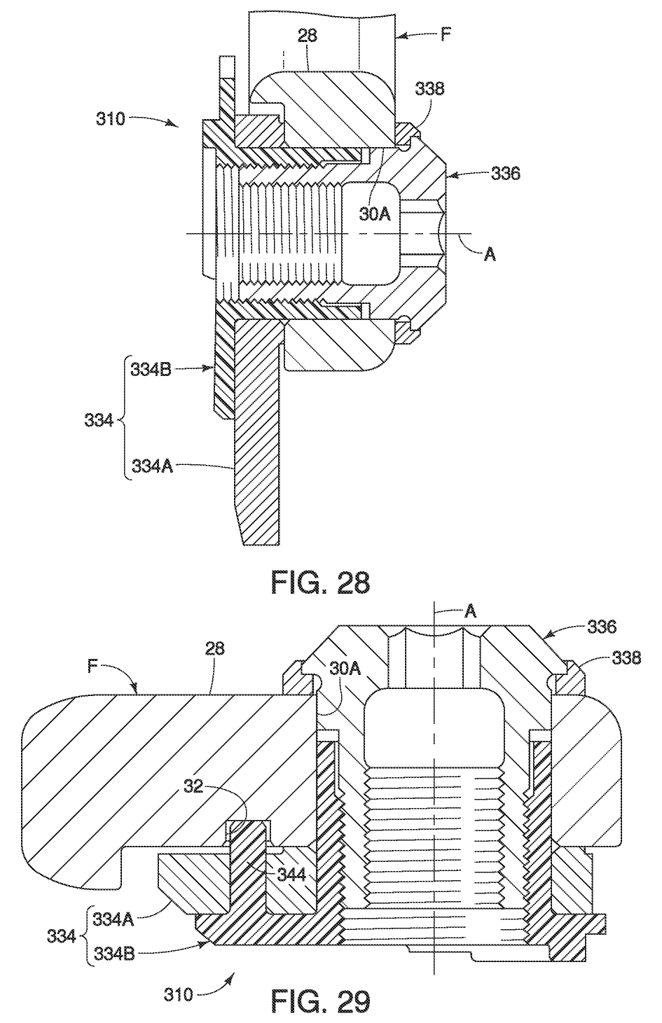

Referring now to FIGS. 24 to 29, a derailleur hanger assembly 310 is illustrated in accordance with a third modification. Basically, the derailleur hanger assembly 310 comprises a derailleur hanger 334, a hanger bolt 336 and a hanger washer 338. The derailleur hanger 334 is provided with a pin 344 to prevent rotation of the derailleur hanger 334 relative to the bicycle frame F until a predetermined force is applied to the derailleur hanger 334 causing the pin 344 to break. Here, the derailleur hanger 334 has a two-piece construction. Namely, the derailleur hanger 334 comprises a first hanger part 334A and a second hanger part 334B. With this modification, the first hanger part 334A can be made of a first material and the second hanger part 334B can be made of a second material that is different from the first material of the first hanger part 334A. For example, the first hanger part 334A is made of a metallic material, while the second hanger part 334B is made of non-metallic material such as plastic. Here, the second hanger part 334B and the pin 344 are integrally formed as a one-piece member. For example, the second hanger part 334B and the pin 344 are molded from a single plastic material to form a one-piece member. Here, the pin 344 is free of a frangible portion. However, the pin 344 can be provided with a frangible portion as needed and/or desired.

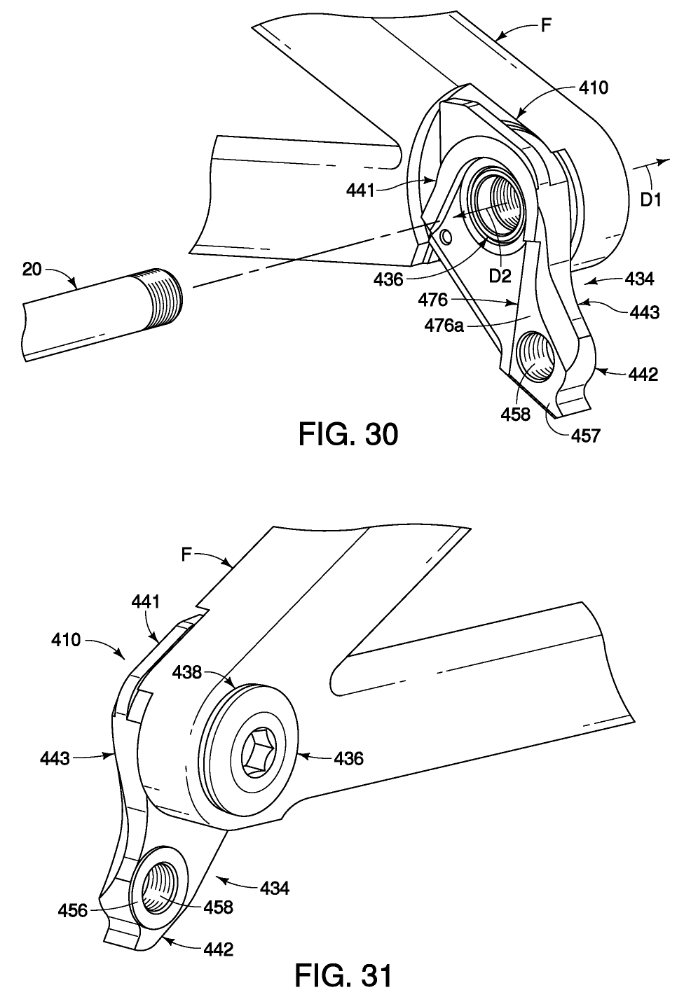

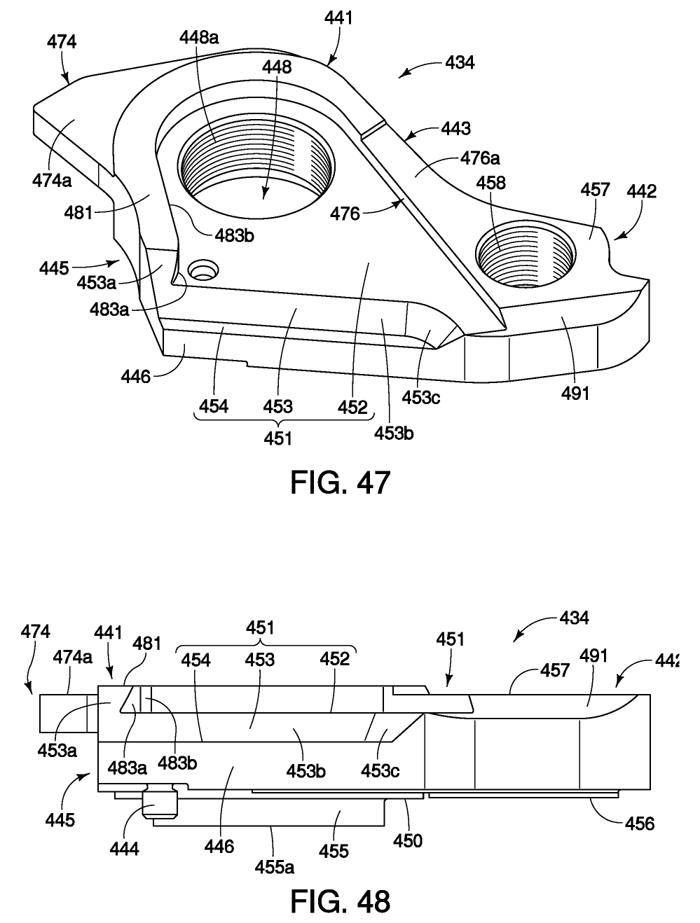

Referring now to FIGS. 30 to 49, a derailleur hanger assembly 410 is illustrated in accordance with another embodiment. Basically, the derailleur hanger assembly 410 is configured to be mounted to the bicycle frame F. The derailleur hanger assembly 410 is configured to support the derailleur 12 (see FIGS. 1 and 2) in the same manner as in the first embodiment. Also, similar to the first embodiment, the hub axle 20 is attached to the derailleur hanger assembly 410 so that the rear hub 14 (see FIGS. 1 to 3) is mounted to the bicycle frame F. The derailleur hanger assembly 410 basically comprises a derailleur hanger 434, a hanger bolt 436 and a hanger washer 438.

The derailleur hanger 434 is a separate part from the bicycle frame F. Specifically, in this embodiment, the derailleur hanger 434 is fixed to the bicycle frame F by the hanger bolt 436. The derailleur hanger 434 is in a mounted state where the derailleur hanger 434 is mounted to the bicycle frame F. The mounted state can also be referred to as an installed state. In the same manner as the first embodiment, the derailleur 12 (see FIGS. 1 and 2) can be fixed to the derailleur hanger 434 by the fixing bolt 18 of the derailleur 12 (see FIGS. 1 and 2). As seen in FIGS. 30 to 35, the derailleur hanger 434 and the hanger bolt 436 are at least partly disposed on opposite sides of the bicycle frame F. Basically, the derailleur hanger 434, the hanger bolt 436 and the hanger washer 438 are aligned with the bicycle frame F because of the axial contact of the derailleur hanger 434 and the hanger washer 438 with the bicycle frame F. Thus, the bicycle frame F is sandwiched between the derailleur hanger 434 and the hanger bolt 436.

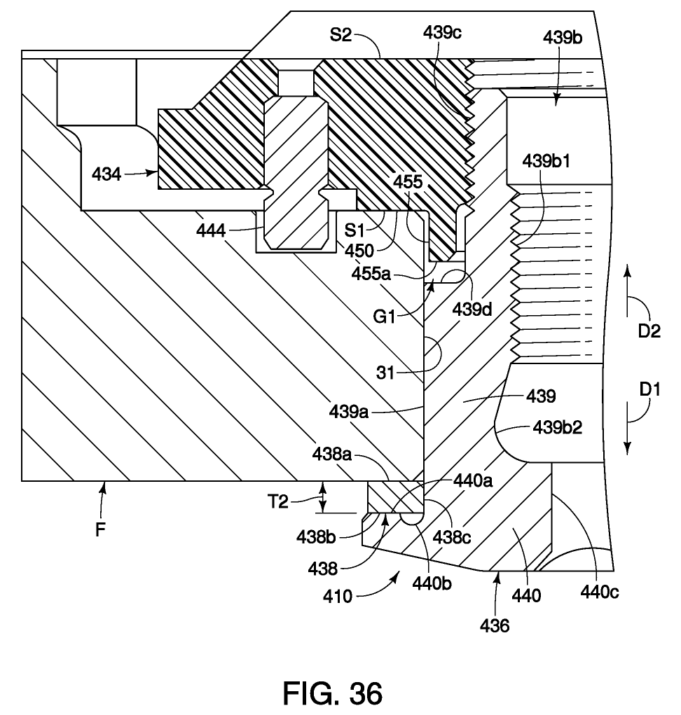

Referring to FIGS. 35 and 36, the hanger bolt 436 includes a shaft portion 439 and a head portion 440. The head portion 440 is coupled to the shaft portion 439. The head portion 440 of the hanger bolt 436 overlaps the bicycle frame F as viewed from the first direction D1. Therefore, the dropping of the hanger 434 or the derailleur 12 from bicycle frame F is suppressed when a user forgets to install the hanger washer 438 during an attachment operation of the hanger 434. Here, the shaft portion 439 and the head portion 440 are a one-piece member. The hanger bolt 436 is preferably made of a metallic material such as aluminum, stainless steel, or the like. The shaft portion 439 includes a non-threaded portion 439a. The non-threaded portion 439a is configured to contact an internal surface 31 defining the mounting opening 30A of the bicycle frame F in the mounted state. The shaft portion 439 further includes an internal bore 439b. The internal bore 439b includes an internally threaded portion 439b1. The internally threaded portion 439b1 is configured to be threadedly coupled to an external thread of the hub axle 20 (see FIGS. 1 to 3). In this way, the shaft portion 439 of the hanger bolt 436 is coupled to the hub axle 20 for attaching the rear hub 14 (see FIGS. 1 to 3) to the bicycle frame F. The internally threaded portion 439b1 preferably has a right-hand thread. The internal bore 439b also has an annular radial recess 439b2. The annular radial recess 439b2 is configured to prevent a free end of the hub axle 20 from interfering with the internal bore 439b of the hanger bolt 436.

The shaft portion 439 includes an externally threaded portion 439c configured to be threadedly coupled to the internal thread of the derailleur hanger 434. The externally threaded portion 439c preferably has a left-hand thread. Thus, in the mounted state of the derailleur hanger 434, the shaft portion 439 of the hanger bolt 436 is threadedly attached to the derailleur hanger 434. Also, with the derailleur hanger 434 in the mounted state, the hub axle 20 is threadedly attached to the hanger bolt 436 for attaching the rear hub 14 to the bicycle frame F. In the mounted state of the derailleur hanger 434, the head portion 440 of the hanger bolt 436 contacts the hanger washer 438. In this way, the bicycle frame F and the hanger washer 438 are sandwiched between the head portion 440 of the hanger bolt 436 and the derailleur hanger 434.

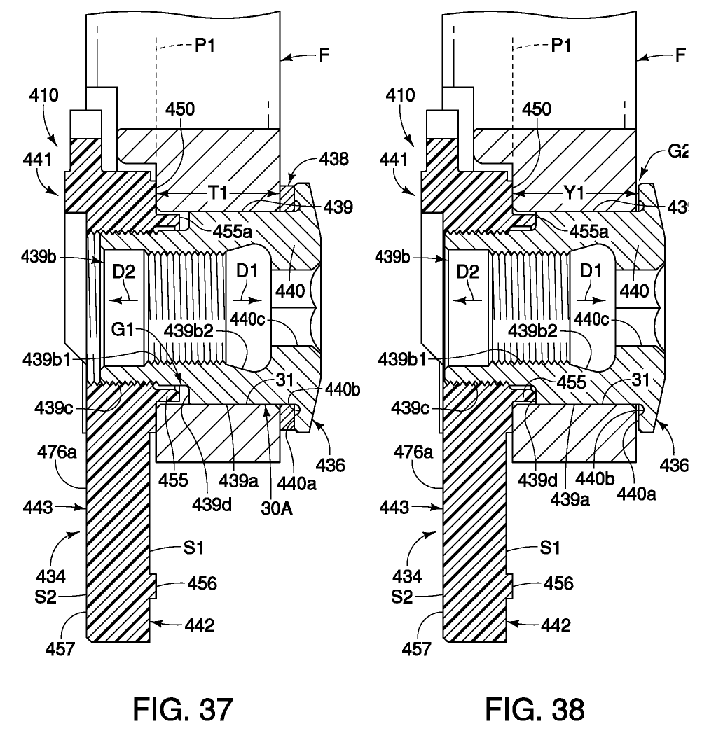

As seen in FIGS. 37 and 38, the head portion 440 has an axial contact surface 440a facing in an axial direction of the shaft portion 439. A distance Y1 between the axial contact surface 440a and the frame attachment surface 450 is larger than a thickness T1 of the bicycle frame F in a state where the hanger bolt 436 is tightened to the derailleur hanger 434 without the hanger washer 438. In a state where the hanger bolt 436 is tightened to the derailleur hanger 434 without the hanger washer 438, the derailleur hanger 434 is not fixedly secured to the bicycle frame F. Rather, the derailleur hanger 434 can be moved relative to the bicycle frame F where the hanger washer 438 is not installed. For example, the derailleur hanger 434 and the hanger bolt 436 can be moved relative to the bicycle frame F in the axial direction of the hanger bolt 436 where the hanger washer 438 is not installed. In this way, a user can readily recognize the state where the hanger bolt 436 is tightened to the derailleur hanger 434 without the hanger washer 438.

The head portion 440 has an annular axial recess 444b extending in the axial direction between the shaft portion 439 and the axial contact surface 440a. The annular axial recess 444b is configured to reduce stress in the head portion 440 of the hanger bolt 436 from tightening the hanger bolt 436 to the derailleur hanger 434. Also, the head portion 440 includes a non-circular tool receiving opening 440c. The non-circular tool receiving opening 440c is configured to receive a tool for tightening and loosening the hanger bolt 436 with respect to the derailleur hanger 434. Of course, it will be apparent from this disclosure that the head portion 440 can have any type of tool receiving structure for receiving a tool to tighten and loosen the hanger bolt 436 with respect to the derailleur hanger 434.

Referring to FIGS. 36, 39 and 40, the hanger washer 438 will now be described in more detail. The hanger washer 438 has a frame contact surface 438a, a bolt contact surface 438b and a bolt receiving opening 438c extending between the frame contact surface 438a and the bolt contact surface 438b. The frame contact surface 438a contacts the bicycle frame F in the state where the hanger bolt 436 is tightened to the derailleur hanger 434 with the hanger washer 438 disposed on the hanger bolt 436 between the bicycle frame F and the head portion 440. On the other hand, the bolt contact surface 438b contacts the head portion 440 in the state where the hanger bolt 436 is tightened to the derailleur hanger 434 with the hanger washer 438 disposed on the hanger bolt 436 between the bicycle frame F and the head portion 440. In this way, the head portion 440 contacts the bolt contact surface 438b in the mounted state where the hanger bolt 436 is tightened to the derailleur hanger 434 with the hanger washer 438 between the bicycle frame F and the head portion 440. The bolt receiving opening 438c is dimensioned to snugly fit on the non-threaded portion 439a of the shaft portion 439 of the hanger bolt 436. In other words, the outer diameter of the non-threaded portion 439a of the shaft portion 439 is equal to or substantially equal to the inner diameter of the bolt receiving opening 438c of the hanger washer 438. The hanger washer 438 are preferably made of a metallic material such as stainless steel.

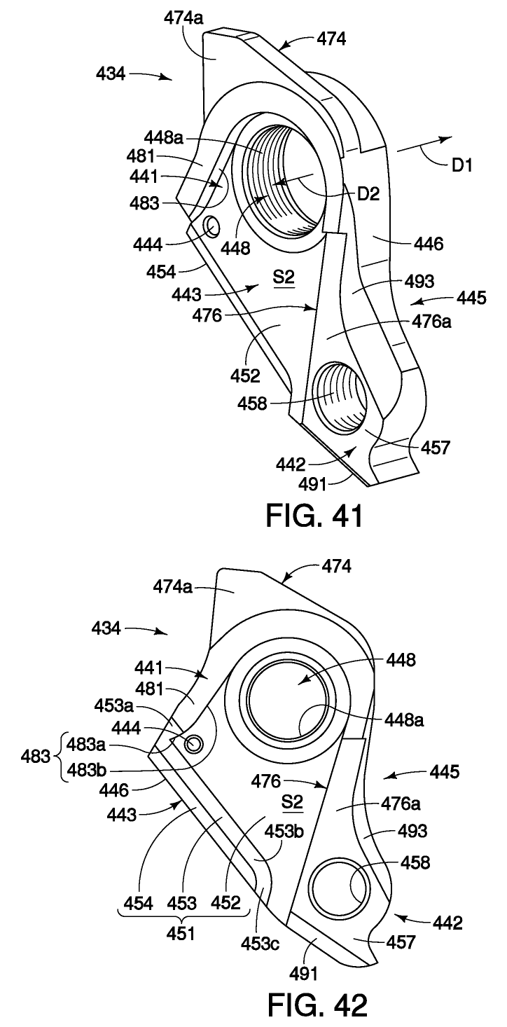

Referring to FIGS. 41 to 48, the derailleur hanger 434 will now be described in more detail. In this embodiment, the derailleur hanger 434 basically comprises a first portion 441, a second portion 442 and a third portion 443. The third portion 443 connects the first portion 441 and the second portion 442. Similar to the first embodiment, the derailleur hanger 434 basically comprises a pin 444. The pin 444 is a frangible pin that is identical to the pin 44 of the first embodiment. Thus, the pin 444 functions in the same manner as the pin 44 of the first embodiment as described above. Thus, the above description of the pin 44 applies to the pin 444.

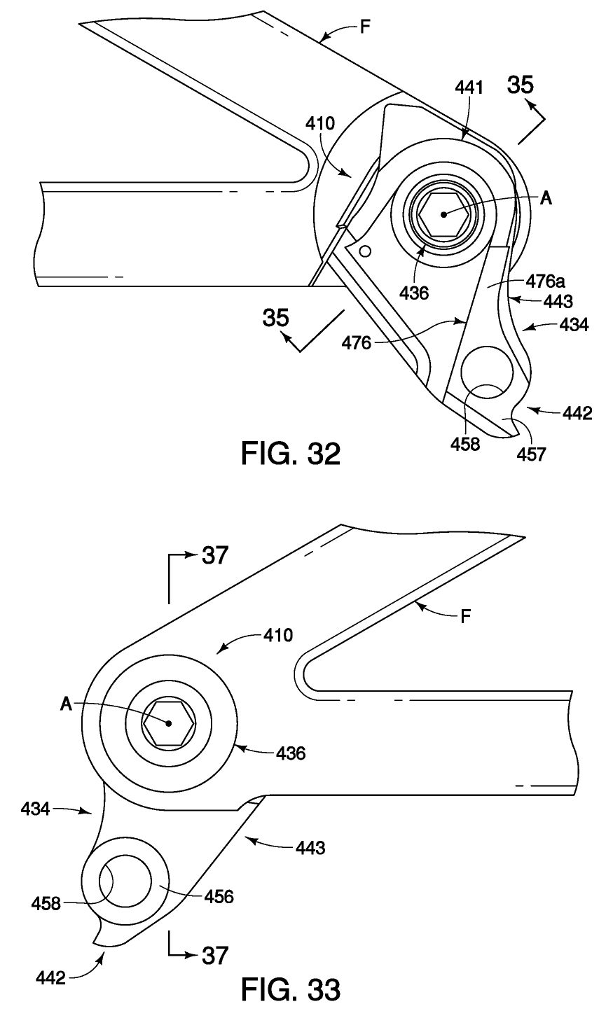

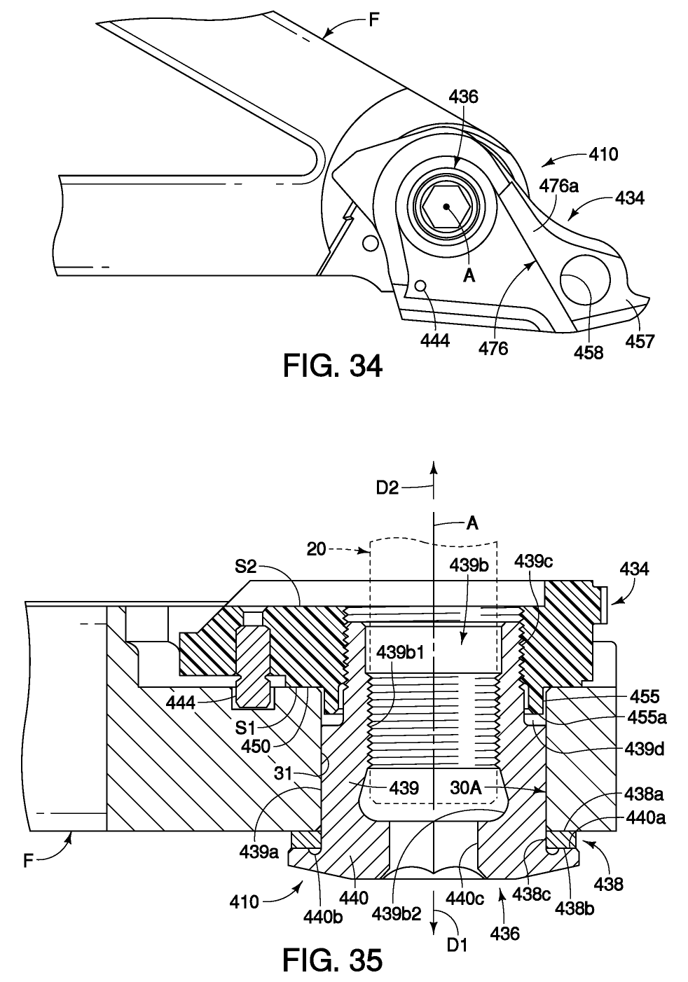

As seen in FIGS. 32 to 36, the pin 444 prevents the derailleur hanger 434 from pivoting relative to the bicycle frame F about the center axis A of the hub axle 20 in the mounted state. However, the pin 444 is configured to break upon application of a predetermined force (e.g., a torque about the center axis A) or higher to the pin 444. When the pin 444 has broken due to the application of a predetermined force or higher to the pin 444 in a rearward direction, the derailleur hanger 434 can pivot rearwardly relative to the bicycle frame F as seen in FIG. 34.

The first portion 441, the second portion 442 and a third portion 443 define a main body 445. Here, the second portion 442 and the third portion 443 are formed as a one-piece member of a suitable material. For example, the first portion 441, the second portion 442 and the third portion 443 is formed of a hard rigid material such as a metal alloy, or a fiber reinforced plastic (e.g., plastic reinforced with carbon fibers or glass fibers). On the other hand, here, the pin 444 is a separate member from the main body 445 (e.g., the first portion 441, the second portion 442 and the third portion 443). In particular, the pin 444 is a separate member that is fixed (e.g., press-fitted) to the third portion 443.

Preferably, the material of the pin 444 is different from the material of the main body 445 of the derailleur hanger 434. For example, the main body 445 of the derailleur hanger 434 is made of a first metallic material (e.g., aluminum) and the pin 444 is made of a second metallic material (e.g., stainless steel). Alternatively, the main body 445 and the pin 444 can be made of the same metallic material as needed and/or desired. Alternatively, the main body 445 of the derailleur hanger 434 is made of a metallic material (e.g., aluminum) and the pin 444 is made of a non-metallic material (e.g., plastic). In any case, the pin 444 is configured to break at a target torque as described below.

The main body 445 has a first side S1. The first side S1 facing in a first direction D1. The main body 445 has a second side facing S2. The second side facing S2 in a second direction D2. The second side S2 faces in a direction opposite the first side S1. The first side S1 can also be referred to as an outer side of the main body 445. The second side facing S2 can also be referred to as an inner side of the main body 445. In other words, the main body 445 has an outer side S1, and an inner side S2. The inner side S2 faces toward the bicycle center plane CP (see FIG. 3) of the bicycle frame F in the mounted state where the derailleur hanger assembly 410 is mounted to the bicycle frame F. The inner side S2 faces in a direction opposite the outer side S1. The main body 445 further includes a peripheral edge 446. The peripheral edge 446 is disposed between the first side S1 and the second side S2.

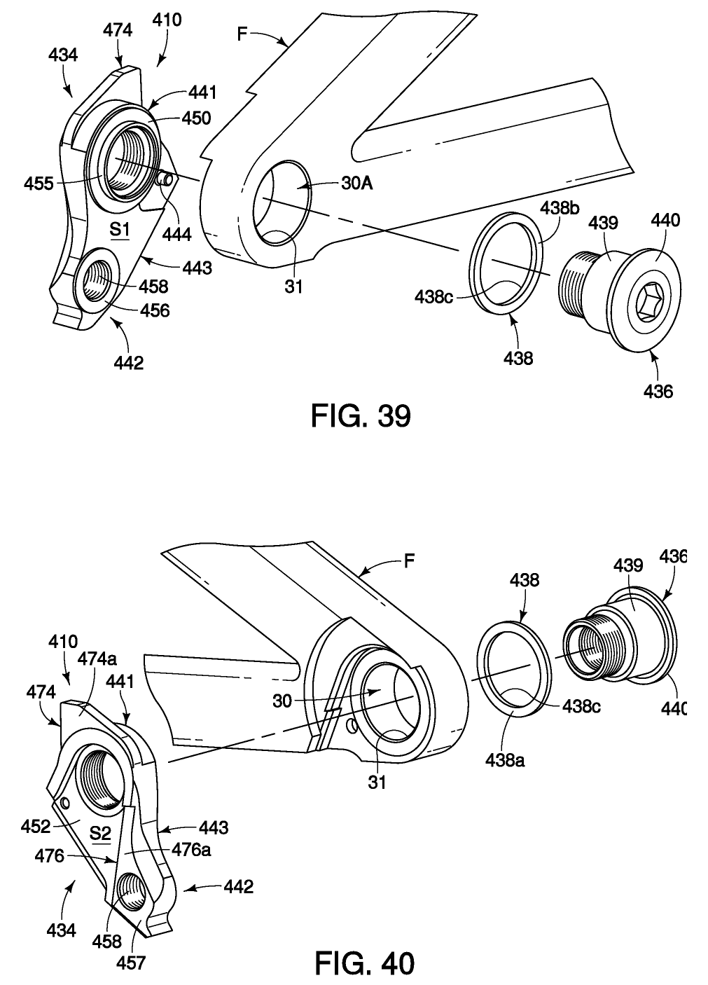

In this embodiment, the first portion 441 is mounted to the hub axle 20. The derailleur hanger 434 includes an axle receiving bore 448. The axle receiving bore 448 has an internal thread 448a. Specifically, as seen in FIGS. 39 to 41, the first portion 441 includes the axle receiving bore 448. The axle receiving bore 448 is configured to receive the hub axle 20. More specifically, the axle receiving bore 448 is configured to threadedly receive the hanger bolt 436, which in turn is configured to threadedly receive the hub axle 20 for mounting the rear hub 14 to the derailleur hanger 434.

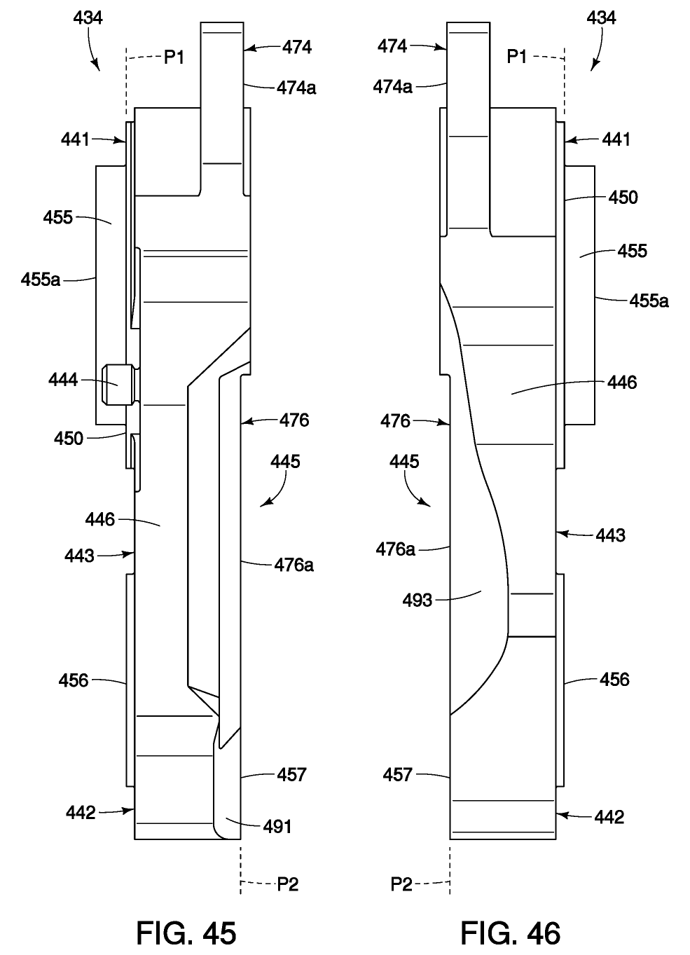

Referring to FIGS. 35 and 36, the derailleur hanger 434 includes a frame attachment surface 450. The frame attachment surface 450 is configured to contact with the bicycle frame F in the mounted state where the derailleur hanger assembly 410 is mounted to the bicycle frame F. Here, the first portion 441 includes the frame attachment surface 450. As seen in FIGS. 45 and 46, the frame attachment surface 450 lies in a plane P1.

Referring to FIG. 42, the main body 445 includes a guide 451. The guide 451 is configured to aid in attaching and detaching the hub 14 with respect to the derailleur hanger 434 by guiding the hub 14 along the first portion 441 and the third portion 443. The guide 451 includes a hub contact surface 452 and an inclined surface 453. The hub contact surface 452 extends along the first portion 441 and the third portion 443. The inclined surface 453 is adjacent to a section of the peripheral edge 446. The inclined surface 453 is inclined relative to the hub contact surface 452. The inclined surface 453 includes a front part 453a that is longer in a hub guiding direction than other parts 453b and 453c of the inclined surface 453. The guide 451 further includes an edge surface 454 disposed between the inclined surface 453 and the peripheral edge 446. The edge surface 454 is less inclined relative to the hub contact surface 452 than the inclined surface 453. The edge surface 454 is a flat surface that is parallel to the hub contact surface 452. The inclined surface 453 has the same function as the inclined surface 72 of the second peripheral edge portion 66 in the first embodiment. The inclined surface 453 is configured to aid in attaching and detaching a hub with respect to the hanger 434.

Referring to FIGS. 37 to 39 and 43, the frame attachment surface 450 faces the first direction D1 in the mounted state. Referring to FIGS. 37 to 40 and 42, the hub contact surface 452 faces the second direction D2 in the mounted state. Thus, the hub contact surface 452 faces in the opposite direction from the frame attachment surface 450 in the mounted state. The frame attachment surface 450 is configured to contact with the bicycle frame F in the mounted state. More specifically, the frame attachment surface 450 contacts the inner facing surface of the bicycle frame F. Thus, the frame attachment surface 450 can also be referred to as a frame contact surface. The frame attachment surface 450 is held in contact with the inner facing surface of the bicycle frame F by the hanger bolt 436, which is attached to the hub axle 20. Referring to FIGS. 37 and 38, the frame attachment surface 450 is disposed in a plane P1 extending perpendicular to an axial direction of the axle receiving bore 448. The hub contact surface 452 is configured to contact the rear hub 14 in the mounted state. Referring to FIG. 41, the hub contact surface 452 is perpendicular to an axial direction of the axle receiving bore 448.

As seen in FIGS. 35, 39 and 43, the first portion 441 further includes a tubular part 455. The tubular part 455 is positioned in the mounting opening 30A in the mounted state. In this way, the tubular part 455 can aid in the locating of the derailleur hanger 434 with respect to the bicycle frame F during the mounting of the derailleur hanger 434 to the bicycle frame F. However, in the same manner as in the first embodiment, the tubular part 455 is configured to avoid contact with the bicycle frame F in the mounted state. In other words, a gap exists between the tubular part 455 and the surface that defines the mounting opening 30A. As a result, the thru-axle 20 is aligned with the bicycle frame F only by the hanger bolt 436. In other words, in the same manner as in the first embodiment, the derailleur hanger 434 does not contribute the alignment and the positioning of the thru-axle 20 to the bicycle frame F.

Referring to FIGS. 36 to 38, the derailleur hanger 434 includes a first abutment 455a. Here, the first abutment 455a is formed on the tubular part 455. The first abutment 455a is spaced apart from the bicycle frame F in the radial direction. The hanger bolt 436 includes a second abutment 439d. The first abutment 455a is in contact with the second abutment 439d in a state where the hanger bolt 436 is tightened to the derailleur hanger 434 without the hanger washer 438. In this way, the hanger bolt 436 is prevented from being tightened to the derailleur hanger 434 despite the absence of a hanger washer (e.g., hanger washer 438). The first abutment 455a is spaced apart from the second abutment 439d in a state where the hanger bolt 436 is tightened to the derailleur hanger 434 with the hanger washer 438. In other words, as seen in FIGS. 36 and 37, a gap G1 is formed in the axial direction between the first abutment 455a and the second abutment 439d in a state where the hanger bolt 436 is tightened to the derailleur hanger 434 with the hanger washer 438. In particular, as seen in FIGS. 36 and 37, the gap G1 between the first abutment 455a and the second abutment 439d is smaller in the axial direction than a thickness T2 of the hanger washer 438 in the axial direction where the hanger bolt 436 is tightened to the derailleur hanger 434 with the hanger washer 43 being provided on the hanger bolt 436. In this way, contact between the first abutment 455a and the second abutment 439d is avoided in a state where the hanger bolt 436 is tightened to the derailleur hanger 434 with the hanger washer 438. Thus, the hanger bolt 436 is tightened to the derailleur hanger 434 without being obstructed by contact between the first abutment 455a and the second abutment 439d.

On the other hand, as seen in FIG. 38, in a state where the hanger bolt 436 is tightened to the derailleur hanger 434 without the hanger washer 438, the first abutment 455a contacts the second abutment 439d so that the derailleur hanger 434 can be moved relative to the bicycle frame F. As a result, a gap G2 is formed between the axial contact surface 440a of the head portion 440 of the hanger bolt 436 and the bicycle frame F as seen in FIG. 38. Thus, in a state where the hanger bolt 436 is tightened to the derailleur hanger 434 without the hanger washer 438, the derailleur hanger 434 is not fixedly secured to the bicycle frame F. In this way, the derailleur hanger 434 and the hanger bolt 436 can be moved relative to the bicycle frame F in the axial direction of the hanger bolt 436 where the hanger washer 438 is not installed. As a result, a user can readily recognize the state where the hanger bolt 436 is tightened to the derailleur hanger 434 without the hanger washer 438.

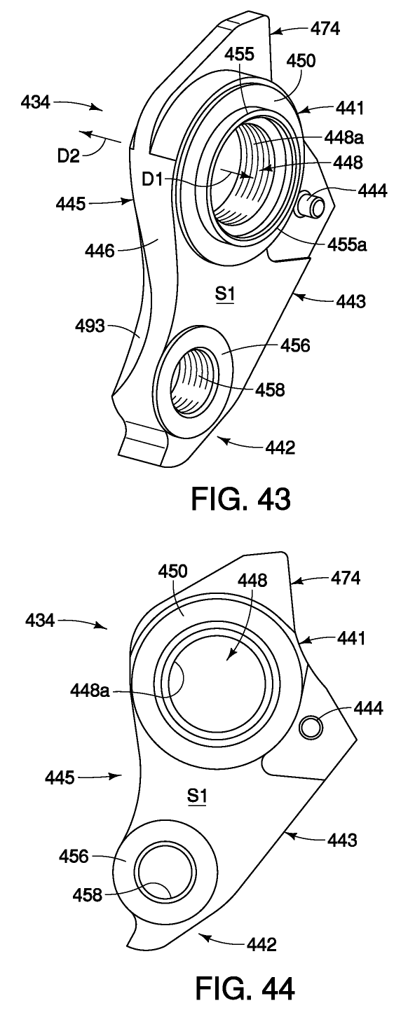

Referring back to FIGS. 39 and 43, the second portion 442 is configured to support the derailleur 12. More specifically, the second portion 442 includes a derailleur support surface 456. The derailleur support surface 456 is configured to support the derailleur 12. In particular, the derailleur 12 contacts the derailleur support surface 456 in this embodiment. The inner side (i.e., the second side S2) includes an opening definition surface 457. The opening definition surface 457 is disposed on the second portion 442. The mounting of the derailleur 12 to the derailleur hanger 434 is not limited to the illustrated arrangement. For example, alternatively, the derailleur 12 can be configured to be mounted to the derailleur hanger 434 such that a mounting part of the derailleur 12 contacts both the derailleur support surface 456 and the opening definition surface 457 of the derailleur hanger 434. In this case, the opening definition surface 457 can also be considered an additional derailleur support surface 457 that faces in the opposite direction to the derailleur support surface 456. In other words, in this alternative mounting configuration where a mounting portion of the derailleur sandwiches the second portion 442, the mounting portion of the derailleur can contact both the derailleur support surface 456 and the additional derailleur support surface 457.

Also, similar to the first embodiment shown in FIGS. 1 and 2, the second portion 442 includes a fixing bolt receiving bore 458. The fixing bolt receiving bore 458 is configured to receive the fixing bolt 18 to support the derailleur 12. The opening definition surface 457 defines an opening 457a of the fixing bolt receiving bore 458. Here, in this embodiment, the fixing bolt receiving bore 458 includes an internal thread that threadedly receives the fixing bolt 18 of the derailleur 12. Alternatively, the fixing bolt receiving bore 458 can be unthreaded and the derailleur 12 can be attached to the second portion 442 using a bolt and a nut. As seen in FIGS. 30 and 31, the derailleur support surface 456 faces in the first direction D1 in the mounted state. As seen in FIGS. 45 and 46, the derailleur support surface 456 is disposed in the plane P1.

Referring now to FIGS. 41 and 42, the derailleur hanger 434 further comprises a first chain restriction portion 474 including a first chain restriction surface 474a. The first chain restriction surface 474a faces in the second direction D2, and is offset from the second surface 62 in the second direction D2. Here, the derailleur hanger 34 further comprises a second chain restriction portion 476 including a second chain restriction surface 476a. The first chain restriction portion 474 and the second chain restriction portion 476 cooperate to aid in preventing a chain from jamming between the first portion 441 of the derailleur hanger 434 and the smallest sprocket of the rear sprocket assembly 16.

The second chain restriction surface 476a can also be referred to as a chain contact surface 476a. Thus, the chain contact surface 476a performs the same function as the second chain restriction surface 76a of the first embodiment as described above. The chain contact surface 476a faces in the second direction D2, and is offset from the second surface 462 in the second direction D2. Here, the chain contact surface 476a lies in the same plane as the first chain restriction surface 474a. The chain contact surface 476a is located around the fixing bolt receiving bore 458. The chain contact surface 476a is located closer to the axle receiving bore 448 than the opening definition surface 457 defining the opening of the axle receiving bore 458. The chain contact surface 476a is located same plane with the additional derailleur support surface 457.

The inner side (i.e., the second side S2) includes the chain contact surface 476a located adjacent to a sprocket tooth 16A1 of the outermost sprocket 16A of the bicycle V in the mounted state. Referring to FIGS. 45 and 46, the chain contact surface 476a is disposed in a plane P2 extending perpendicular to an axial direction of the axle receiving bore 448. In this embodiment, the opening definition surface 457 is disposed in the plane P2. By designing the derailleur hanger 434 such that the opening definition surface 457 and the chain restriction surface 476a are disposed in the same plane, it is easy to set the relative position of the chain CN and the derailleur hanger 434. However, the opening definition surface 457 and the chain restriction surface 476a do not need to be in the same plane.

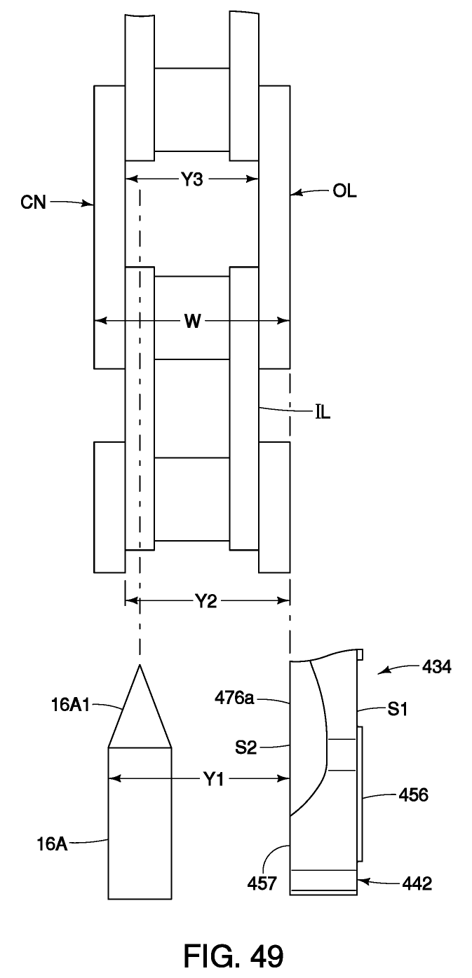

Referring to FIG. 49, the chain contact surface 476a is spaced from an inward surface of the sprocket tooth 16A1 of the outermost sprocket 16A by a first axial distance Y1 that is smaller than a width W of the chain CN. Still referring to FIG. 49, the chain contact surface 476a is spaced from a tooth tip of the sprocket tooth 16A1 of the outermost sprocket 16A such that the tooth tip aligns with an inner chain plate IP of the chain CN as view in parallel to the plane P2 of the chain contact surface 476a where an outer chain plate OP of the chain CN contacts the chain contact surface 476a. The first axial distance Y1 is smaller than a second axial distance Y2 between the chain contact surface 476a and a farthest link surface of the outer link OL of the chain CN defining an inner space Y3 of the outer link OL.

The main body 445 further includes a ridge surface 481. The hub contact surface 452 is recessed relative to the ridge surface 481 with respect to the axial direction to form an abutment surface 483 between the hub contact surface 452 and the ridge surface 481. The abutment surface 483 has an entrance portion 483a and a guiding portion 483b. The guiding portion 483b extends between the first portion 441 and the entrance portion 483a. The entrance portion 483a is arranged along a ridge line that extends so as to be inclined with respect to the guiding portion 483b as view in the axial direction.

Referring to FIGS. 41, 42 and 45 to 48, the second portion 442 of the main body 445 includes a first chamfer 491 on the inner side (i.e., the second side S2) adjacent to the peripheral edge 446 for avoiding interference with the derailleur 12 in the mounted state. The first chamfer 491 is disposed below the fixing bolt receiving bore 458 in the mounted state of the derailleur hanger 434. The first chamfer 491 is inclined relative to the opening definition surface 457 defining the opening of the axle receiving bore 458. The opening definition surface 457 and the first chamfer 491 are adjoining to form an edge therebetween. The first chamfer 491 is also inclined relative to the hub contact surface 452 and the chain contact surface 476a.

The second portion 442 of the main body 445 includes a second chamfer 493 on the inner side (i.e., the second side S2) adjacent to the peripheral edge 446 for avoiding the chain CN from riding on the derailleur hanger 434 where the chain CN rotates in a reverse pedaling direction. The second chamfer 493 adjoins the chain contact surface 476a and the opening definition surface 457 defining the opening of the axle receiving bore 458.

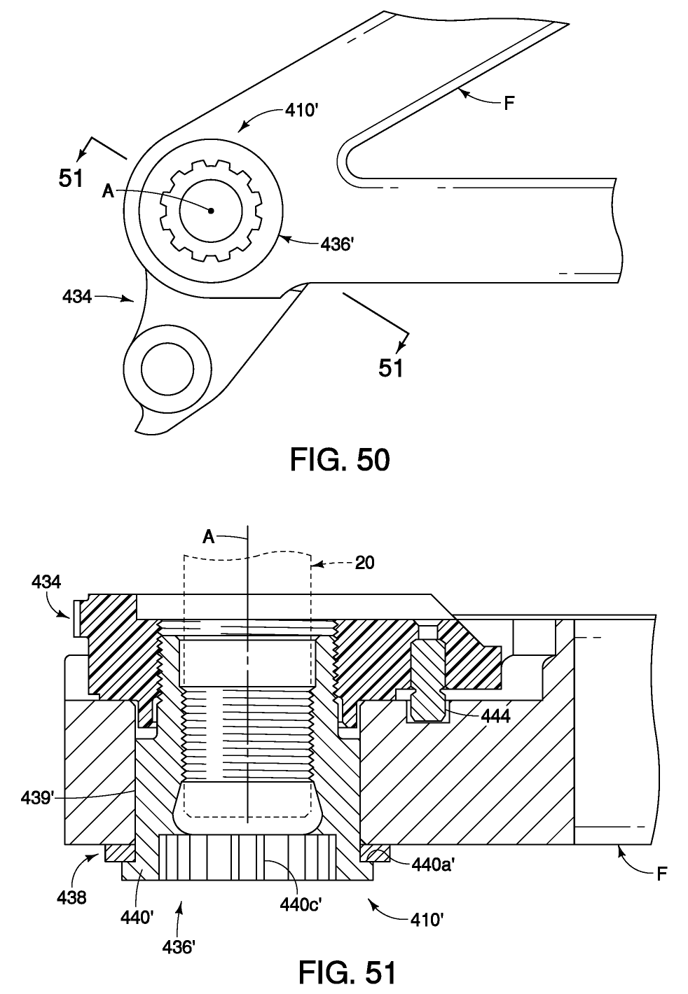

Referring now to FIGS. 50 and 51, a derailleur hanger assembly 410ʹ is illustrated having a modified hanger bolt 436ʹ. The derailleur hanger assembly 410ʹ is identical to the derailleur hanger assembly 410, discussed above, except that the hanger bolt 436ʹ is used instead of the hanger bolt 436. In view of the similarity between the derailleur hanger assembly 410ʹ and the derailleur hanger assembly 410, the parts of the derailleur hanger assembly 410ʹ that are identical to the parts of the derailleur hanger assembly 410 be given the same reference numerals as the parts of the derailleur hanger assembly 410. Moreover, the descriptions of the parts of the derailleur hanger assembly 410ʹ that are identical to the parts of the derailleur hanger assembly 410 may be omitted for the sake of brevity.

Here, the hanger bolt 436ʹ has a shaft portion 439ʹand a head portion 440ʹ. The shaft portion 439ʹ is basically the same as the shaft portion 439 described above. The head portion 440ʹ has an axial contact surface 440aʹ facing in an axial direction of the shaft portion 439ʹ. The axial contact surface 440aʹ contacts the hanger washer 438, which is described above. The head portion 440ʹ includes a non-circular tool receiving opening 440cʹ. Here, the non-circular tool receiving opening 440cʹ is formed by a plurality of splines..

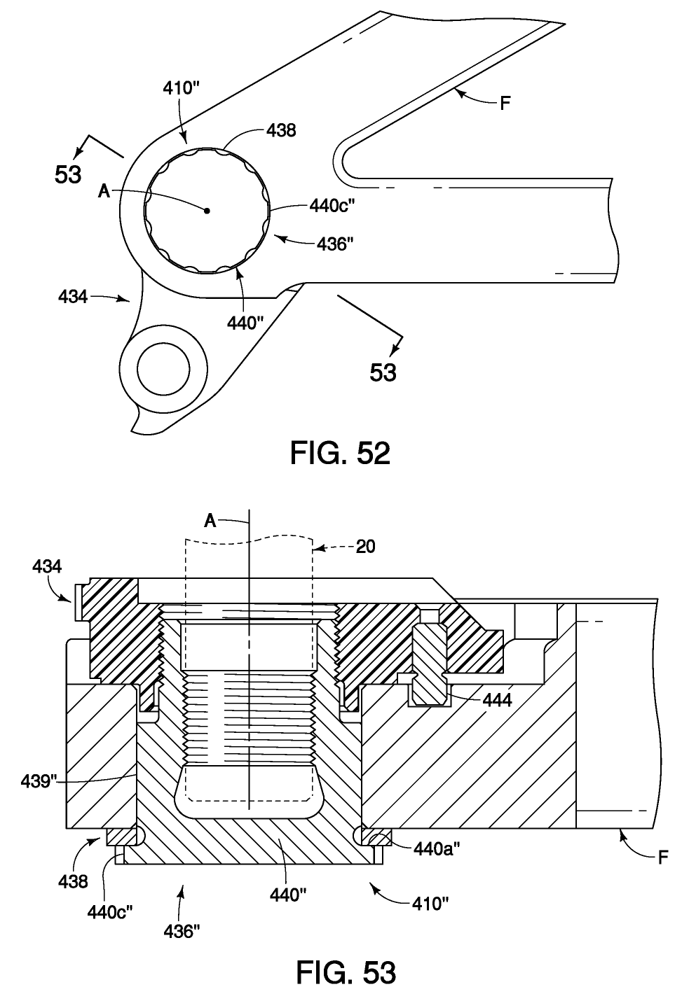

Referring now to FIGS. 52 and 53, a derailleur hanger assembly 410ʹʹ is illustrated having a modified hanger bolt 436ʹʹ. The derailleur hanger assembly 410ʹʹ is identical to the derailleur hanger assembly 410, discussed above, except that the hanger bolt 436ʹʹ is used instead of the hanger bolt 436. In view of the similarity between the derailleur hanger assembly 410ʹʹ and the derailleur hanger assembly 410, the parts of the derailleur hanger assembly 410ʹʹ that are identical to the parts of the derailleur hanger assembly 410 be given the same reference numerals as the parts of the derailleur hanger assembly 410. Moreover, the descriptions of the parts of the derailleur hanger assembly 410ʹʹ that are identical to the parts of the derailleur hanger assembly 410 may be omitted for the sake of brevity.

Here, the hanger bolt 436ʹʹ has a shaft portion 439ʹʹand a head portion 440ʹʹ. The shaft portion 439ʹʹ is basically the same as the shaft portion 439 described above. The head portion 440ʹʹ has an axial contact surface 440aʹʹ facing in an axial direction of the shaft portion 439ʹʹ. The axial contact surface 440aʹʹ contacts the hanger washer 438, which is described above. The head portion 440ʹʹ includes an outer peripheral tool receiving surface 440cʹʹ. Here, the outer peripheral tool receiving surface 440cʹʹ is formed by a plurality of notches formed on the outer periphery of the head portion 440ʹʹ.

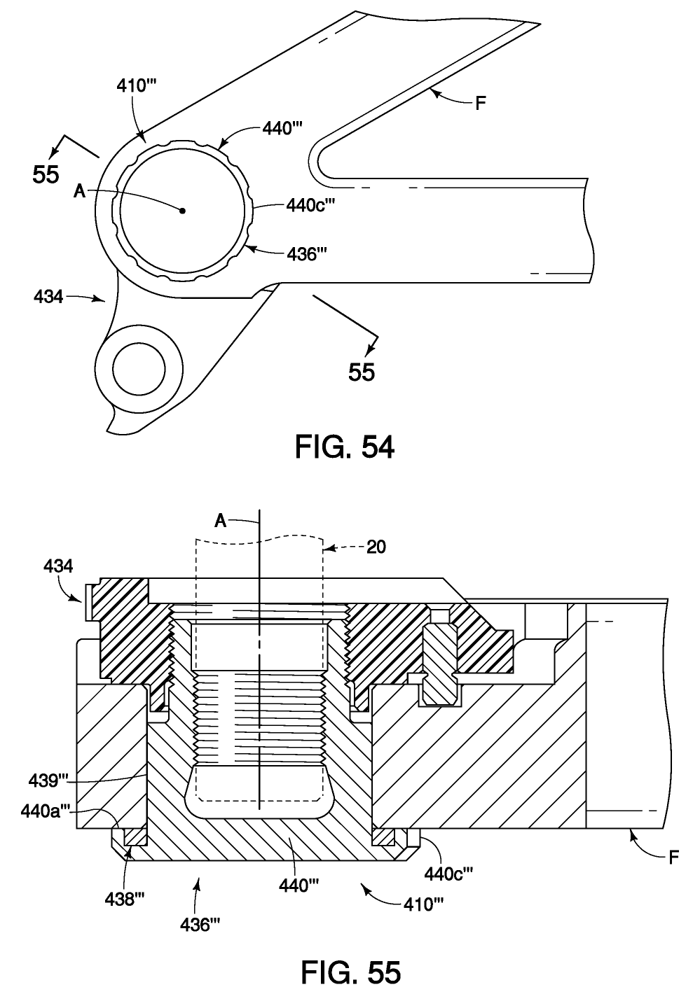

Referring now to FIGS. 54 and 55, a derailleur hanger assembly 410ʹʹʹ is illustrated having a modified hanger bolt 436ʹʹʹ and a modified hanger washer 438ʹʹʹ. The derailleur hanger assembly 410ʹʹʹ is identical to the derailleur hanger assembly 410, discussed above, except that the hanger bolt 436ʹʹʹ and the hanger washer 438ʹʹʹ are used instead of the hanger bolt 436 and the hanger washer 438. In view of the similarity between the derailleur hanger assembly 410ʹʹʹ and the derailleur hanger assembly 410, the parts of the derailleur hanger assembly 410ʹʹʹ that are identical to the parts of the derailleur hanger assembly 410 be given the same reference numerals as the parts of the derailleur hanger assembly 410. Moreover, the descriptions of the parts of the derailleur hanger assembly 410ʹʹʹ that are identical to the parts of the derailleur hanger assembly 410 may be omitted for the sake of brevity.

Here, the hanger bolt 436ʹʹʹ has a shaft portion 439ʹʹʹand a head portion 440ʹʹʹ. The shaft portion 439ʹʹʹ is basically the same as the shaft portion 439 described above. The head portion 440ʹʹʹ has an axial contact surface 440aʹʹʹ facing in an axial direction of the shaft portion 439ʹʹ. The axial contact surface 440aʹʹʹ contacts the hanger washer 438, which is described above. The head portion 440ʹʹʹ includes an outer peripheral tool receiving surface 440cʹʹʹ. Here, the outer peripheral tool receiving surface 440cʹʹʹ is formed by a plurality of notches formed on the outer periphery of the head portion 440ʹʹ. Also, here, the outer peripheral tool receiving surface 440cʹʹʹ surrounds the hanger washer 438ʹʹʹ.

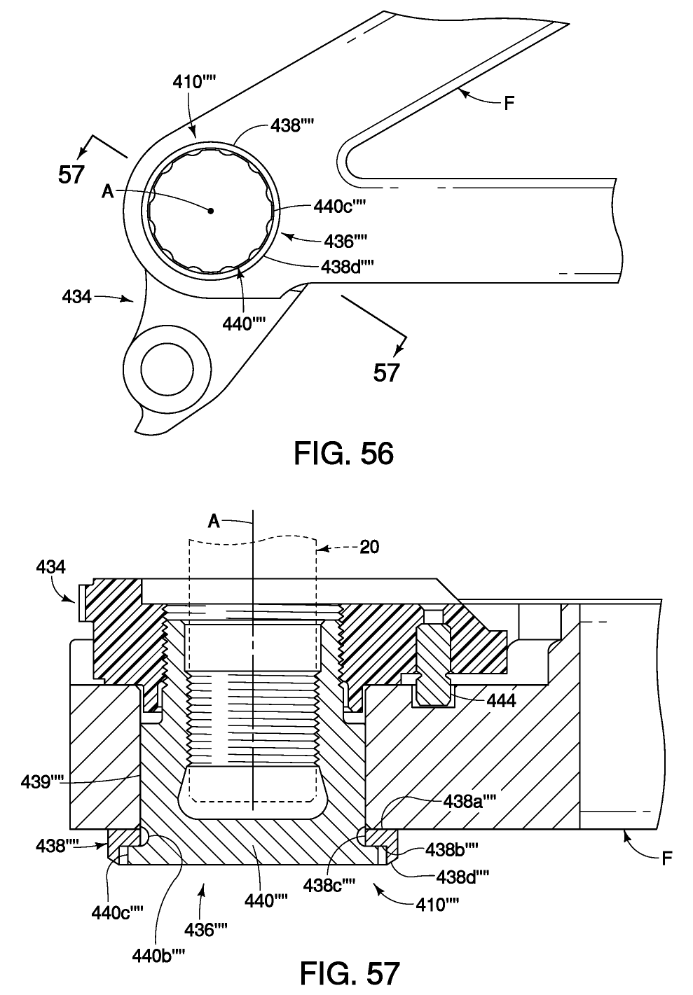

Referring now to FIGS. 56 and 57, a derailleur hanger assembly 410ʹʹʹʹ is illustrated having a modified hanger bolt 436ʹʹʹʹ. The derailleur hanger assembly 410ʹʹʹʹ is identical to the derailleur hanger assembly 410, discussed above, except that the hanger bolt 436ʹʹʹʹ and the hanger washer 438ʹʹʹʹ are used instead of the hanger bolt 436 and the hanger washer 438. In view of the similarity between the derailleur hanger assembly 410ʹʹʹʹ and the derailleur hanger assembly 410, the parts of the derailleur hanger assembly 410ʹʹʹʹ that are identical to the parts of the derailleur hanger assembly 410 be given the same reference numerals as the parts of the derailleur hanger assembly 410. Moreover, the descriptions of the parts of the derailleur hanger assembly 410ʹʹʹʹ that are identical to the parts of the derailleur hanger assembly 410 may be omitted for the sake of brevity.

Here, the hanger bolt 436ʹʹʹʹ has a shaft portion 439ʹʹʹʹand a head portion 440ʹʹʹʹ. The shaft portion 439ʹʹʹʹ is basically the same as the shaft portion 439 described above. The head portion 440ʹʹʹʹ has an axial contact surface 440aʹʹʹʹ facing in an axial direction of the shaft portion 439ʹʹʹʹ. The axial contact surface 440aʹʹʹʹ contacts the hanger washer 438ʹʹʹʹ. The head portion 440ʹʹʹʹ includes an outer peripheral tool receiving surface 440cʹʹʹʹ. Here, the outer peripheral tool receiving surface 440cʹʹʹʹ is formed by a plurality of notches formed on the outer periphery of the head portion 440ʹʹʹʹ. The hanger washer 438ʹʹʹʹ has a frame contact surface 438aʹʹʹʹ, a bolt contact surface 438bʹʹʹʹ and a bolt receiving opening 438cʹʹʹʹ extending between the frame contact surface 438aʹʹʹʹ and the bolt contact surface 438bʹʹʹʹ. The frame contact surface 438aʹʹʹʹ contacts the bicycle frame F in the state where the hanger bolt 436ʹʹʹʹ is tightened to the derailleur hanger 434ʹʹʹʹ with the hanger washer 438ʹʹʹʹ disposed on the hanger bolt 436ʹʹʹʹ between the bicycle frame F and the head portion 440ʹʹʹʹ. On the other hand, the bolt contact surface 438bʹʹʹʹ contacts the head portion 440ʹʹʹʹ in the state where the hanger bolt 436 is tightened to the derailleur hanger 434ʹʹʹʹ with the hanger washer 438ʹʹʹʹ disposed on the hanger bolt 436ʹʹʹʹ between the bicycle frame F and the head portion 440ʹʹʹʹ. Also, here, the hanger washer 438ʹʹʹʹ has an annular portion 438dʹʹʹʹ that surrounds the outer peripheral tool receiving surface 440cʹʹʹʹ.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a bicycle in an upright, riding position and equipped with the derailleur hanger. Accordingly, these directional terms, as utilized to describe the derailleur hanger should be interpreted relative to a bicycle in an upright riding position on a horizontal surface and that is equipped with the derailleur hanger. The terms “left” and “right” are used to indicate the “right” when referencing from the right side as viewed from the rear of the bicycle, and the “left” when referencing from the left side as viewed from the rear of the bicycle.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A derailleur hanger assembly comprising:
a derailleur hanger including an axle receiving bore having an internal thread and a frame attachment surface configured to contact with a bicycle frame in a mounted state where the derailleur hanger assembly is mounted to the bicycle frame;
a hanger washer having a frame contact surface, a bolt contact surface and a bolt receiving opening extending between the frame contact surface and the bolt contact surface; and
a hanger bolt including a shaft portion and a head portion coupled to the shaft portion, the head portion having an axial contact surface facing in an axial direction of the shaft portion,
the shaft portion including an externally threaded portion configured to be threadedly coupled to the internal thread of the derailleur hanger,
a distance between the axial contact surface and the frame attachment surface being larger than a thickness of the bicycle frame in a state where the hanger bolt is tightened to the derailleur hanger without the hanger washer.

2. The derailleur hanger assembly according to claim 1, wherein
the derailleur hanger includes a first abutment,
the hanger bolt includes a second abutment, and
the first abutment is in contact with the second abutment in a state where the hanger bolt is tightened to the derailleur hanger without the hanger washer.

3. The derailleur hanger assembly according to claim 2, wherein
the first abutment is spaced apart from the second abutment in a state where the hanger bolt is tightened to the derailleur hanger with the hanger washer.

4. The derailleur hanger assembly according to claim 1, wherein
the shaft portion includes a non-threaded portion configured to contact an internal surface defining a mounting opening of the bicycle frame in the mounted state, and
the head portion contacts the bolt contact surface in the mounted state where the hanger bolt is tightened to the derailleur hanger with the hanger washer between the bicycle frame and the head portion.

5. The derailleur hanger assembly according to claim 1, wherein
the head portion has an annular axial recess extending in the axial direction between the shaft portion and the axial contact surface.

6. The derailleur hanger assembly according to claim 1, wherein
the head portion includes a non-circular tool receiving opening.

7. The derailleur hanger assembly according to claim 1, wherein
the shaft portion includes an internal bore having an internally threaded portion configured to be threadedly coupled to an external thread of a hub axle.

8. The derailleur hanger assembly according to claim 7, wherein
the internal bore has an annular radial recess configured to prevent a free end of the hub axle from interfering with the internal bore of the hanger bolt.

9. A derailleur hanger comprising:
a first portion including an axle receiving bore configured to receive a hub axle;
a second portion including a derailleur support surface configured to support a derailleur; and
a third portion connecting the first portion and the second portion to define a main body,
the main body including a first side facing in a first direction, a second side facing in a second direction, and a peripheral edge disposed between the first side and the second side,
the main body including a guide configured to aid in attaching and detaching a hub with respect to the derailleur hanger by guiding the hub along the first portion and the third portion,
the guide including a hub contact surface extending along the first portion and the third portion, and an inclined surface adjacent to a section of the peripheral edge and the inclined surface being inclined relative to the hub contact surface.

10. The derailleur hanger according to claim 9, wherein
the hub contact surface is perpendicular to an axial direction of the axle receiving bore.

11. The derailleur hanger according to claim 9, wherein
the guide further includes an edge surface disposed between the inclined surface and the peripheral edge, the edge surface is less inclined relative to the hub contact surface than the inclined surface.

12. The derailleur hanger according to claim 11, wherein
the edge surface is a flat surface that is parallel to the hub contact surface.

13. The derailleur hanger according to claim 9, wherein
the main body further includes a ridge surface, the hub contact surface is recessed relative to the ridge surface with respect to the axial direction to form an abutment surface between the hub contact surface and the ridge surface.

14. The derailleur hanger according to claim 13 wherein
the abutment surface has an entrance portion and a guiding portion,
the guiding portion extends between the first portion and the entrance portion, and
the entrance portion is arranged along a ridge line that extends so as to be inclined with respect to the guiding portion as view in the axial direction.

15. The derailleur hanger according to claim 9, wherein
the inclined surface includes a front part that is longer in a hub guiding direction than other parts of the inclined surface.

16. A derailleur hanger comprising:
a first portion including an axle receiving bore configured to receive a hub axle;
a second portion including a fixing bolt receiving bore configured to receive a fixing bolt to support a derailleur; and
a third portion connecting the first portion and the second portion,
the first portion, the second portion and a third portion defining a main body having an inner side facing towards a bicycle center plane of a bicycle frame in a mounted state where the derailleur hanger assembly is mounted to the bicycle frame, the inner side including a chain contact surface located adjacent a sprocket tooth of an outermost sprocket of the bicycle in the mounted state, the inner side including an opening definition surface defining an opening of the fixing bolt receiving bore,
the chain contact surface being disposed in a plane extending perpendicular to an axial direction of the axle receiving bore, the opening definition surface being disposed in the plane, and
the chain contact surface being spaced from an inward surface of the sprocket tooth of the outermost sprocket by a first axial distance that is smaller than a width of a chain.

17. The derailleur hanger according to claim 16, wherein
the chain contact surface is spaced from a tooth tip of the sprocket tooth of the outermost sprocket such that the tooth tip aligns with an inner chain plate of the chain as view in parallel to the plane of the chain contact surface where an outer chain plate of the chain contacts the chain contact surface.

18. The derailleur hanger according to claim 16, wherein
the first axial distance is smaller than a second axial distance between the chain contact surface and a farthest link surface of an outer link of the chain defining an inner space of the outer link.

19. The derailleur hanger according to claim 16, wherein
the main body includes an outer side facing in a direction opposite the inner side and a peripheral edge disposed between the outer side and the inner side, and
the second portion of the main body includes a first chamfer on the inner side adjacent to the peripheral edge for avoiding interference with a derailleur in the mounted state.

20. The derailleur hanger according to claim 16, wherein
the main body includes an outer side facing in a direction opposite the inner side and a peripheral edge disposed between the outer side and the inner side, and
the second portion of the main body includes a second chamfer on the inner side adjacent to the peripheral edge for avoiding the chain from riding on the derailleur hanger where the chain rotates in a reverse pedaling direction.
